(19) United States
(12) Patent Application Publication
(10) Pub. No.: US 2003/0053427 A1
(43) Pub. Date: Mar. 20, 2003

(54) Mobile terminal, router, communication node, packet transfer method

(75) Inventors: Mitsuru Kanda, Tokyo (JP); Naoki Esaka, Kanagawa-ken (JP); Satoshi Ozaki, Kanagawa-ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 10/244,455

(22) Filed: Sep. 17, 2002

(30) Foreign Application Priority Data
Sep. 18, 2001 (JP) 2001-284073

(51) Int. Cl. H04Q 7/00

(52) U.S. Cl. 370/328; 370/338

(57) ABSTRACT

A mobile terminal transmits an extended packet including address-range information and a no-operation designator. After a router receives the extended packet including the no-operation designator, it transfers the received packet by performing normal routing. After a server receives the transferred packet, it transmits a response packet in the form of an extended packet including a destination address which is the transmitter's address of the received packet, the address-range information, and an operation designator. After the router receives the extended packet including the operation designator in an intranet to which the mobile terminal belongs, it transfers the received packet through at least one network interface corresponding to the address range designated by the address-range information. The mobile terminal processes the received packet when its destination address indicates the mobile terminal.

### BACKGROUND OF THE INVENTION

1. Field of the Invention

The present invention relates to a mobile terminal whose address can change when it moves, a router unit, a node unit that communicates with the mobile terminal, a mobile agent that transfers a packet, a packet transfer method, and a mobile agent processing method.

2. Description of the Related Art

Recently, portable terminals which include or can be connected to communication units or cellular phones having Internet-link functions have come into widespread use. Each portable terminal is linked to a router by a radio communication station or the like, and when it moves to different a radio communication area, it is linked to a different router and its Internet protocol (IP) address may change.

It is impossible for a device that employs an end-to-end model, such as the Transmission Control Protocol (TCP), to maintain a session when its address changes. Thus, while a mobile terminal is communicating with a node such as a server after being linked to the Internet, if the mobile terminal moves to a different radio communication area, and its address changes, a packet from the node to the mobile terminal disappears, so that the communication cannot be continued.

### SUMMARY OF THE INVENTION

In view of the above-described circumstances, it is an object of the present invention to provide a mobile terminal in which, even if the mobile terminal moves while communicating with a node, it is able to continue the communication, a router unit, a node unit, a mobile agent, a packet transfer method, and a mobile agent processing method.

To this end, according to an aspect of the present invention, a packet transfer method between a mobile terminal which can move from 1st network associated with 1st router to 2nd network associated with 2nd router, and a communication node through the Internet, comprising transmitting 1st packet including address-range designating information for designating the range of address to which said mobile terminal can move, and NOP (no-operation designating information), from said mobile terminal to said 1st router, toward said communication node, in said mobile terminal, forwarding received 1st packet by performing normal routing, from 1st router toward said communication node, in said 1st router, receiving said 1st packet transmitted by said 1st router, in said communication node, transmitting 2nd packet from said communication node toward said mobile terminal, including said address-range designating information as destination address-range and ACTION (operating designating information), in response to the 1st packet received by said communication node, receiving said 2nd packet from said communication node, in said 2nd router, forwarding received 2nd packet through at least one network interface with corresponds to the address range based on the address-range designating information in the received another extended packet, from said 2nd router toward said mobile terminal, receiving said 2nd packet from said 2nd router, when the destination address of the transferred extended packet indicates said mobile terminal.

According to another aspect of the present invention, a mobile terminal which can change the mobile terminal's present address when the mobile terminal moved, comprising: a packet transmitting unit transmits, toward a communication node with which said mobile terminal communicates, 1st packet including address-range designating information for designating the range of addresses to which said mobile terminal can move, and a packet receiving unit receives 2nd packet which includes the address-range designating information and which is addressed to said mobile terminal, from said communication node. According to another aspect of the present invention, a router for packet forwarding, comprising: a communication interface unit having a plurality of network interfaces, a receiving unit receives one of a normal packet, and an extended packet including address-range designating information for designating the range of addresses to which a packet is transferred and one of operation designating information for designating packet transfer to the designated address range and NOP (no-operation designating information) for designating normal routing, 1st forwarding unit forwards received one of the normal packet and/or the packet including the NOP, by using the normal routing, 2nd forwarding unit forwards received the packet including the ACTION (operating designating information), through at least one of the network interfaces which corresponds to the address range based on the address-range designating information included in the received packet.

According to another aspect of the present invention, a communication node for use in communication with a mobile terminal whose present address can change when said mobile terminal moves, comprising: a packet receiving unit receives, from said mobile terminal, 1st packet including address-range designating information for designating the range of addresses to which said mobile terminal can move, and a packet transmitting unit transmits, toward said mobile terminal, 2nd packet including address-range designating information designated by said mobile terminal.

According to another aspect of the present invention, a program for controlling a computer to function as a mobile terminal whose present address can change when said mobile terminal moves, said program causing said computer to implement the functions of: transmitting, to a node with which said mobile terminal communicates, an extended packet including address-range designating information for designating the range of addresses to which said mobile terminal can move, and receiving an extended packet which includes the address-range designating information and which is addressed to said mobile terminal.

According to another aspect of the present invention, a program for controlling a computer to function as a router unit for packet relaying, said program causing said computer to implement the functions of: receiving one of a normal packet, and an extended packet including address-range designating information for designating the range of addresses to which a packet is transferred and one of operation designating information for designating packet transfer to the address range designated by the address-range designating information and no-operation designating information for designating normal routing, when one of the normal packet and the extended packet including the no-operation designating information is received, transferring the received packet by using the normal routing, and when an extended packet including the operation designating information is received, transferring the received extended packet through at least one of the network interfaces which corresponds to the address range based on the address-range designating information included in the received extended packet.

In the present invention, by supplying, from a mobile terminal to another party with which the mobile terminal communicates, address-range designating information for designating the range of addresses (i.e., the range of addresses to which a packet must be transferred when the other party perform packet transmission to the mobile terminal) to which the mobile terminal can move, transmitting, from the other party to the mobile terminal, an extended packet including the address-range designating information, and transferring, with a router, the extended packet (or reproductions thereof if needed) to at least one address corresponding to the address range, continuous communication is performed, with an end-to-end session maintained, even if the mobile terminal has moved and its present address changes. Also, by performing broadcasting and multicasting in a limited range, an adverse effect to the node, such as the occurrence of an unnecessary interruption, can be reduced. Information to be managed and an overhead decreases and the number of codes for use can be reduced.

### BRIEF DESCRIPTION OF THE DRAWINGS

FIG. 1 is a block diagram showing a network system according to an embodiment of the present invention;

FIG. 2 is an illustration of an IPv6 address in an embodiment of the present invention;

FIG. 3 is an illustration of the format of an extended header in an embodiment of the present invention;

FIG. 4 is a block diagram showing a router in an embodiment of the present invention;

FIG. 5 is a flowchart showing a packet transfer process according to an embodiment of the present invention;

FIG. 6 is a block diagram showing a mobile terminal according to an embodiment of the present invention;

FIG. 7 is a flowchart showing a process in which the mobile terminal according to an embodiment of the present invention performs address acquisition and setting after moving;

FIG. 8 is a flowchart showing a process performed by the mobile terminal according to an embodiment of the present invention when a packet to be transmitted is generated;

FIG. 9 is a flowchart showing a process of the mobile terminal according to an embodiment of the present invention when it receives a packet;

FIG. 10 is a block diagram showing a packet receiving process performed by the mobile terminal according to an embodiment of the present invention;

FIG. 11 is a flowchart showing a process performed by a server according to an embodiment of the present invention when it receives a request;

FIG. 12 is a flowchart showing a process in which a message is transmitted in the form of an extended packet from one other party with which the mobile terminal according to an embodiment of the present invention communicates to the mobile terminal;

FIG. 13 is a flowchart showing a process in which one other party with which the mobile terminal according to an embodiment of the present invention communicates transmits a message in the form of a normal packet to the mobile terminal after transmitting a probe packet;

FIG. 14 is a flowchart showing a process performed by the mobile terminal according to an embodiment of the present invention when it receives the probe packet;

FIG. 15 is a block diagram showing an example of communication between the mobile terminal according to an embodiment of the present invention and a server;

FIG. 16 is a block diagram showing an example of communication between the mobile terminal according to an embodiment of the present invention and a server;

FIG. 17 a block diagram showing an example of communication between the mobile terminal according to an embodiment of the present invention and a server;

FIG. 18 is a block diagram showing an example of a mobile agent according to an embodiment of the present invention;

FIG. 19 is a block diagram showing the mobile agent according to an embodiment of the present invention;

FIG. 20 is a flowchart showing an example of a process performed by the mobile agent according to an embodiment of the present invention;

FIG. 21 is a block diagram showing an example of the mobile agent according to an embodiment of the present invention;

FIG. 22 is a block diagram showing an example of the mobile agent according to an embodiment of the present invention;

FIG. 23 is a block diagram showing an example of the mobile agent according to an embodiment of the present invention;

FIG. 24 is a block diagram showing an example of the mobile agent according to an embodiment of the present invention;

FIG. 25 is a block diagram showing an example of the mobile agent according to an embodiment of the present invention;

FIG. 26 is a block diagram showing an example of the mobile agent according to an embodiment of the present invention;

FIG. 27 is a flowchart showing another process performed by the mobile agent according to an embodiment of the present invention;

FIG. 28 is a block diagram showing a case in which the mobile terminal according to an embodiment of the present invention moves after casting a multicast packet or a unicast packet in a single intranet;

FIG. 29 is a block diagram showing a case in which the mobile terminal according to an embodiment of the present invention moves after casting a multicast packet or a unicast packet in a single intranet;

FIG. 30 is a block diagram showing a case in which the mobile terminal according to an embodiment of the present invention moves after casting a multicast packet or a unicast packet in a single intranet;

FIG. 31 is a block diagram showing a case in which the mobile terminal according to an embodiment of the present invention moves after casting a multicast packet or a unicast packet in a single intranet;

FIG. 32 is block diagram showing an example of a network system for a case in which two mobile terminals according to an embodiment of the present invention which communicate with each other move;

FIG. 33 is a block diagram showing the communication between two mobile terminals;

FIG. 34 is a block diagram showing the communication between two mobile terminals according to an embodiment of the present invention;

FIG. 35 is a block diagram showing the communication between two mobile terminals according to an embodiment of the present invention; and

FIG. 36 is a block diagram showing the communication between two mobile terminals according to an embodiment of the present invention.

### DESCRIPTION OF THE PREFERRED EMBODIMENTS

Embodiments of the present invention are described below with reference to the accompanying drawings.

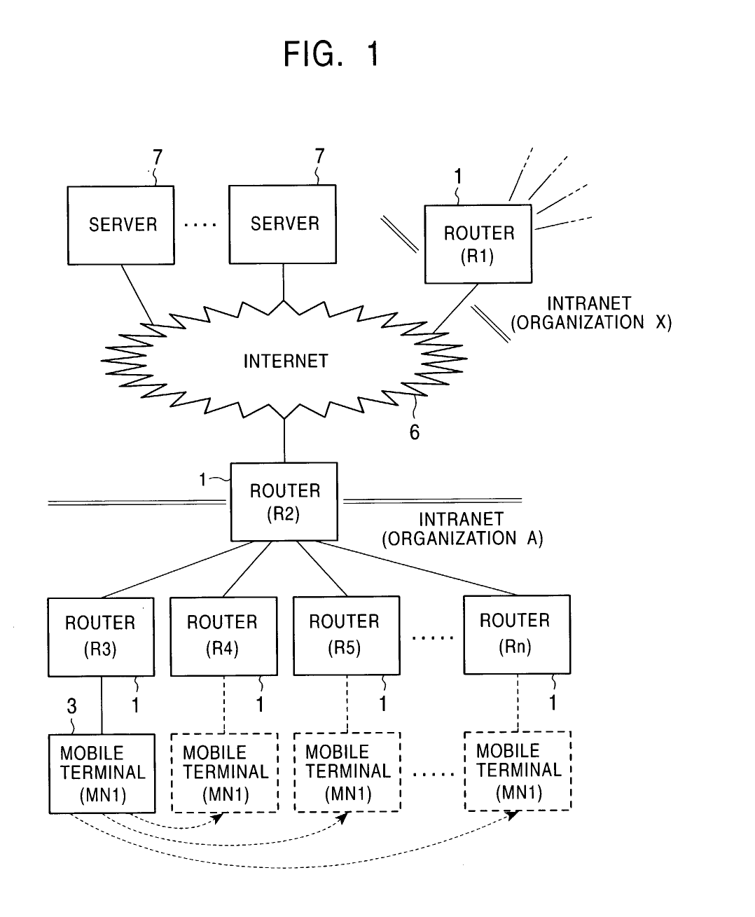

FIG. 1 shows the structure of a network system according to an embodiment of the present invention.

As shown in FIG. 1, a plurality of intranets (e.g., organizations A and X) and a plurality of servers 7 are linked to the Internet 6. Intranets and servers that do not have the functions of the embodiment may be connected to the Internet 6.

Each intranet has a boundary router 1 (R2 or R1 in FIG. 1) in the boundary between it and the Internet 6. Other routers (hereinafter also referred to as “internal routers”) are connected to the router 1 on the inner side of the boundary. The connection relationship of the boundary router 1 in the intranet may have any structure. The boundary router 1 and the other routers 1 are basically identical in structure. The boundary router 1 may have a function and a device which are unique thereto, and each internal router 1 may have a function and a device which are unique thereto.

The intranet (organization A) in FIG. 1 is described below as an example.

The intranet (organization A) includes the boundary router R2, and in an example of the internal structure of the intranet, a plurality of routers R3 to Rn are connected to the boundary router R2 in the inner side therefrom (opposing the Internet 6).

There is a mobile terminal 3 inside the intranet (organization A). Although FIG. 1 shows only one radio terminal (MN1) as the mobile terminal 3, actually there can be a plurality of mobile terminals 3.

The mobile terminal 3 is provided with a radio unit and has the ability to move between the internal routers 1. In this case, each internal router 1 can have or can be linked to at least one radio station or unit (not shown) for radio communication with the mobile terminal 3.

The mobile terminal 3 may be of any type such as a portable computer having a built-in radio communication function, a portable computer to which a radio communication function can externally be provided, or a cellular phone terminal having an Internet-link function or the like.

In FIG. 1, the servers 7 are examples of other parities (nodes) on the Internet 6 with which the mobile terminal 3 communicates. However, other parities (nodes) on the Internet 6 with which the mobile terminal 3 communicates may be nodes other than the servers 7. Also, there are possible cases in which the mobile terminal 3 communicates with another mobile terminal 3 in the same intranet, and in which the mobile terminal 3 communicates with a mobile terminal 3 in a different intranet.

Here, an IPv6 address used in this embodiment is described below.

Each mobile terminal in this embodiment has an IPv6 address.

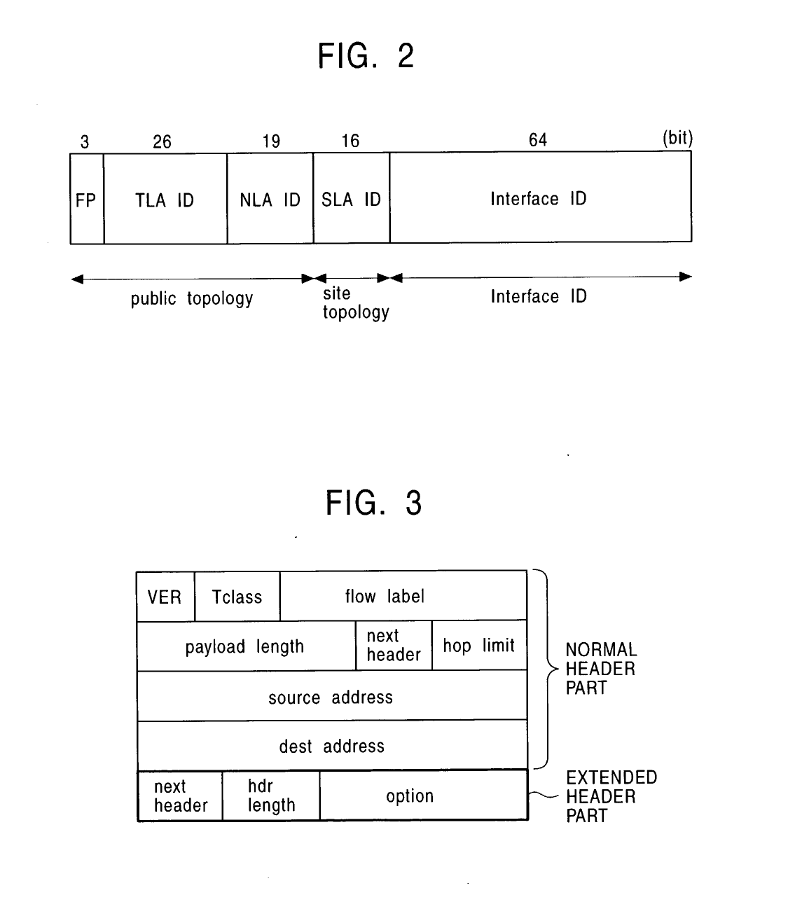

As FIG. 2 shows, the IPv6 address (see Request for Comments (RFC) 2928) includes:

TLA ID (Top Level Aggregation ID);

NLA ID (Next Level Aggregation ID);

SLA ID (Site Level Aggregation ID); and

Interface_ID (64 bits). In the following description, “FP (format prefix)” is omitted.

Referring to the mobile terminal MN1, the IPv6 address MN1_addr of the mobile terminal MN1 is actually changed when the mobile terminal MN1 moves from the internal router R3 to Rn. Thus, in accordance with the router 1 to which the mobile terminal MN1 is linked, the prefix (upper part from Interface_ID) of the IPv6 address changes. The Interface_ID does not change.

The Interface_ID is defined in the 64-bit extended unique identifier (EUI-64) (the IEEE, “Guide lines for 64 bit Global Identifier Registration Authority”), and its uniqueness (global uniqueness) is guaranteed.

When the IPv6 address MN1_addr of the mobile terminal MN1, obtained when the mobile terminal MN1 is under a router Ri, is described as “MN1_addr@Ri”, the IPv6 address MN1_addr®R3 of the mobile terminal MN1, obtained when the mobile terminal MN1 is under the router R3 in FIG. 1, is formed by:

TLA ID;

NLA ID;

SLA ID (a value indicating that the mobile terminal MN1 is under the router R3); and

Interface_ID (64 bits), and

the IPv6 address MN1_addr@Rn of the mobile terminal MN1, obtained when the mobile terminal MN1 moves to the router Rn, is formed by:

TLA ID;

NLA ID;

SLA ID (a value indicating that the mobile terminal MN1 is under the router Rn); and

Interface_ID (64 bits).

Then, MN1_addr@R3 and MN1_addrRn are different IPv6 addresses since the SLA_IDs differ in at least one bit.

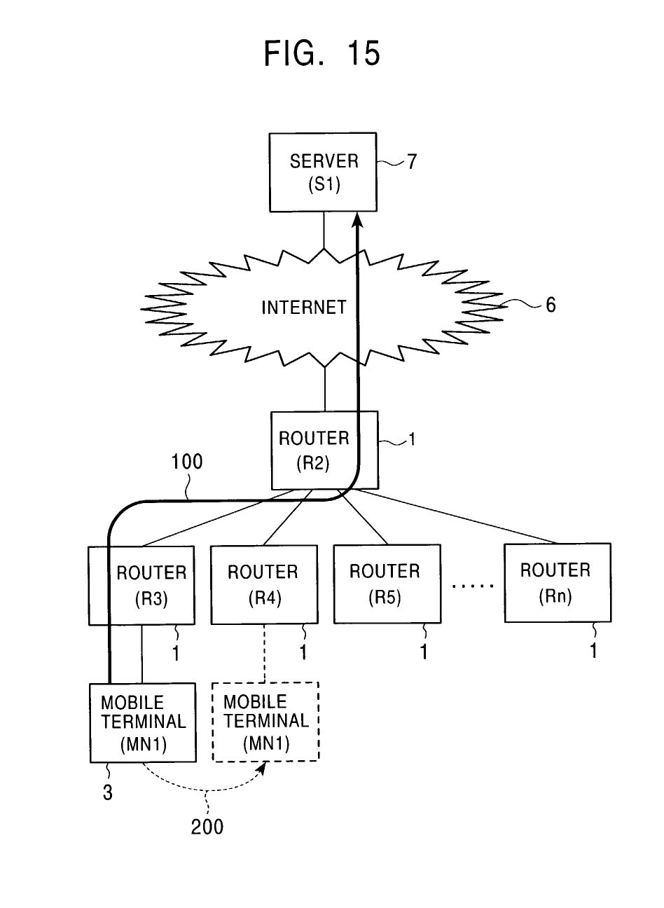

By way of example, in FIG. 1, when the mobile terminal MN1 under the router R3 transmits a request message to one server 7 (by using a normal header packet) while communicating with the server 7 (see reference numeral 100 in FIG. 15), and moves from the router R3 to R4 before receiving a response message from the server 7 (see reference numeral 200 in FIG. 15), the server 7 cannot know the change of the present address of the mobile terminal MN1 to MN1_addr@R4 at the time the mobile terminal MN1 has moved. In this case, if the server 7 transmits (in the form of a normal packet) the response message to the request massage passing through the router R3 by using, as a destination, the address of the mobile terminal MN1 with respect to the router R3, the packet addressed to MN1_addr@R3 does not reach the mobile terminal MN1 at the address MN1_addr@R4, so that the communication cannot be continued.

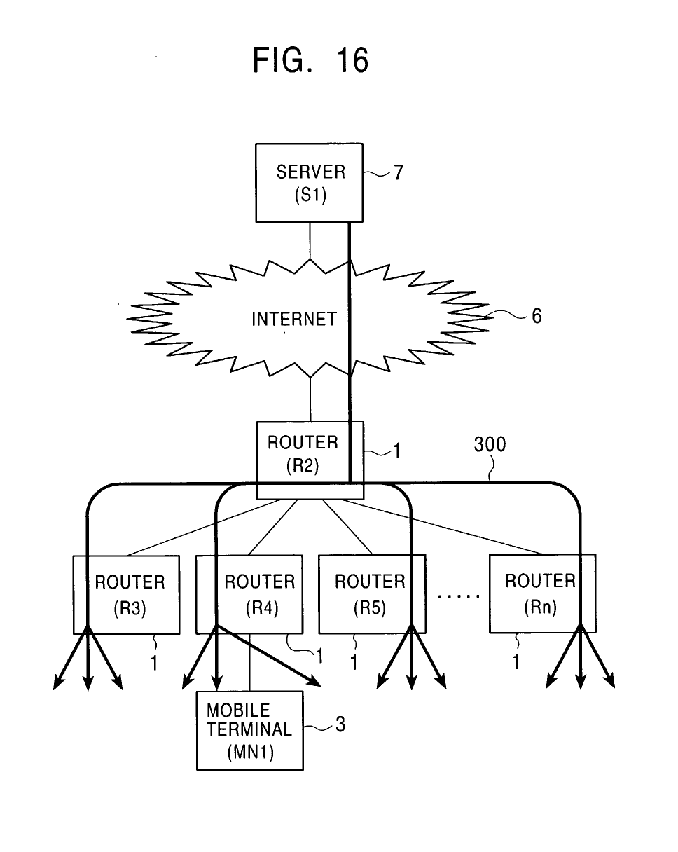

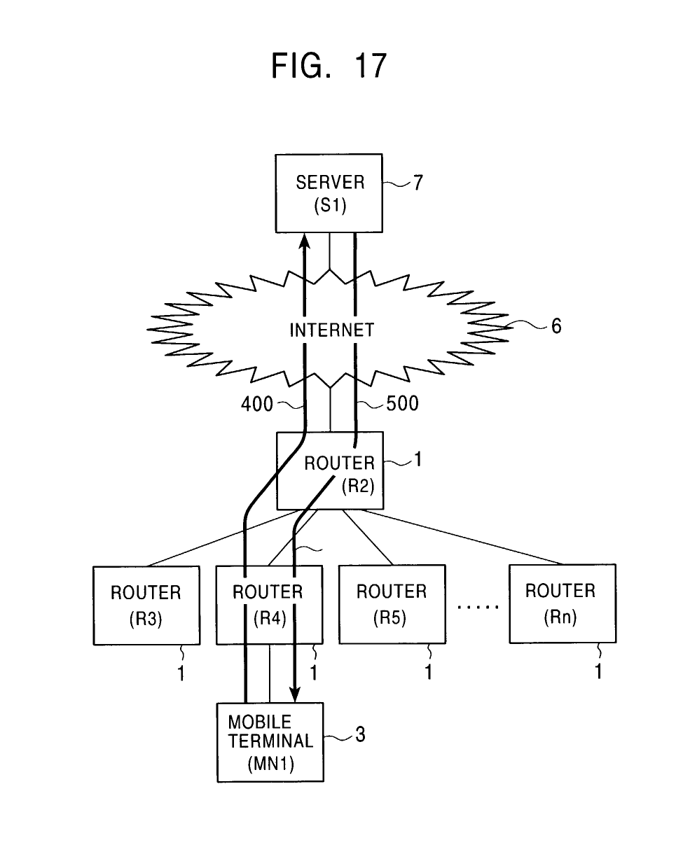

Accordingly, in this embodiment, (when a predetermined condition is satisfied such as a case where a possibility of motion (or a possibility of changing the address) occurs) the mobile terminal 3 transmits to another party (e.g., the server 7) a packet including the range of possible addresses to which the mobile terminal 3 may move (for example, notifies the other party by describing the range of possible addresses in the request message indicated by 100 in FIG. 15), and the other party transmits a data packet that is broadcasted in the posted address range (see reference numeral 300 in FIG. 16). This enables the data packet to reach the mobile terminal 3 so that the communication can be continued. Alternatively, the other party (e.g., the server 7) transmits a probe packet (a packet querying the present address) that is broadcasted in the posted address range (see reference numeral 300 in FIG. 16), and the mobile terminal 3 responds to the other party with the present address, whereby the communication can be performed by using normal packets (see reference numerals 400 and 500 in FIG. 17).

In this embodiment, an extended header is used to post the range of addresses to which the mobile terminal 3 can move and to designate local broadcasting and the range of addresses for broadcasting.

A packet (extended packet) having an extended header in the embodiment is described below.

FIG. 3 shows an example of the format of the extended header for use in this embodiment. As shown in FIG. 3, the extended header is obtained by adding an extended header part to a normal header part. The normal header consists of 4-bit “version” (indicated by “VER”) which represents the version of the IP and in which “6” represents IPv6 and “4” represents IPv4, 4-bit “priority” (indicated by “Tclass”) representing the priority of the packet, 24-bit “flow label” which is a labeling function to be added when a transmitter requests for real-time information such as VOD, 16-bit “payload length” representing the length of the packet (user data) excluding the IPv6 header, 8-bit “next header” representing the a header type following the IPv6 header, 8-bit “hop limit” representing the limit number of times the packet is relayed by the router, 128-bit “source address” representing a transmitter's address, and 128-bit “destination address” (indicated by “dest address”) representing a header type following the extended header.

The extended header consists of 8-bit “next header” representing a header type following the extended header, and option data.

Next, the posting of the range of possible addresses to which the mobile terminal 3 moves, and a format example for designating local broadcasting and the address range for broadcasting are described below.

In this embodiment, the mobile terminal 3 can supply a network interface with all the addresses that the mobile terminal 3 acquires whenever moving, as described later.

Referring to the mobile terminal MN1, when the mobile terminal MN1 transfers an extended packet to the other party (e.g., the server 7 in FIG. 1), it describes the address of the other party in the normal header part, and describes, as the transmitter's address, one of the IPv6 addresses (e.g., MN1_addr@R3 and MN1_addr@R4) of the mobile terminal MN1, for example, MN1_addr@R3 that is used when the mobile terminal MN1 initiates communication with the server 7.

Also, when the extended packet is transferred from the other party (e.g., the server 7 in FIG. 1) as a node to the mobile terminal MN1, the other party describes, as the destination address in the normal header part, the address of the mobile terminal MN1 that the node recognizes, and the node's address as the transmitter's address.

In other words, the other party may treat the mobile terminal 3 as if it was at the address described in the normal header part, despite the actual address of the mobile terminal 3.

Next, the extended header part in this embodiment is described below.

The range of possible addresses to which the mobile terminal 3 may move, that is, the address range for local broadcasting, is designated by using a hop-by-hop option field in the extended header (describing address-range designating information in the option field).

To designate the address range, the SLA ID of an IPv6 address to which the packet must be transferred is described. For describing the SLA ID, there are various methods. For example, in one method, SLA IDs to be designated may be enumerated. In another method, to reduce the number of bits required for address designation, a set of the offset in the SLA ID portion (16-bit string) and the number of bits therefrom is described. When there are sets of the offsets in the SLA ID portions and the numbers of bits therefrom, the sets are enumerated.

In the option field in the extended header, in addition to the address-range designating information, a packet type for identifying the extended header is described. In this case, a packet type representing the extended header for local broadcasting or multicasting is described. The packet type representing the extended header has a designator designating one of no operation or action. When the designator designates action, a router that can process the extended header is instructed to produce reproductions of the packet and to transfer the reproductions to the addresses of the designated range. When the designator designates no operation, the router is instructed to perform nothing (to perform normal routing). An extended packet having a no-operation designator has functions of notifying the other party of the address-range designating information and of prompting the other party to transmit an extended packet having an action designator.

When a request message is transmitted from the mobile terminal MN1 to the server 7, the request message is transmitted by using an extended packet in which a designator is set to designate no operation (see reference numeral 100 in FIG. 15). In this case, the request message reaches the server 7 similarly to the normal packet. When a response message to the request message is transmitted back from the server 7 to the mobile terminal MN1, the response message is transmitted by using an extended packet which has address-range designating information identical to that described in the extended header part of the request message and in which a designator is set to designate action (see reference numeral 300 in FIG. 16). In this case, the response message is transferred to all the addresses described in the address-range designating range. If the mobile terminal MN1 is at one of the addresses, the response message can reach the mobile terminal MN1.

In the option field in the extended header part, other control information of various types may be described. For example, the types include information indicating whether or not a router that cannot interpret the extended header part of this packet type may abandon the packet, and information indicating whether or not, in a midway path, a router may change the content (e.g., an address-range designating information and/or a designator) of the extended header part of a packet type.

In the following description, the extended header means an extended header for local broadcasting or multicasting in this embodiment, and the extended packet means a packet having this extended header for local broadcasting or multicasting.

The basic structure and operation of each node in this embodiment are described below.

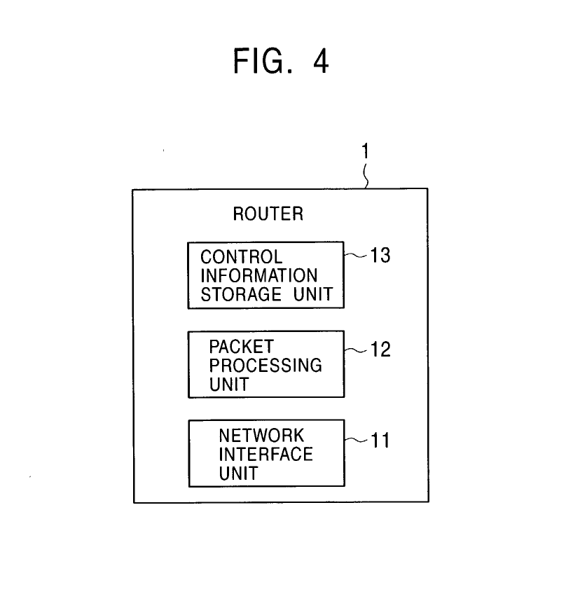

FIG. 4 shows the structure of the router 1 in this embodiment. As shown in FIG. 4, the router 1 includes a network interface unit 11 having a plurality of network interfaces, a packet processing unit 12 for performing processing for packet transfer, and a control information storage unit 13 for storing a path table to be accessed for packet transfer, other control information, etc., if needed. The router 1 may have other functions and devices, as required.

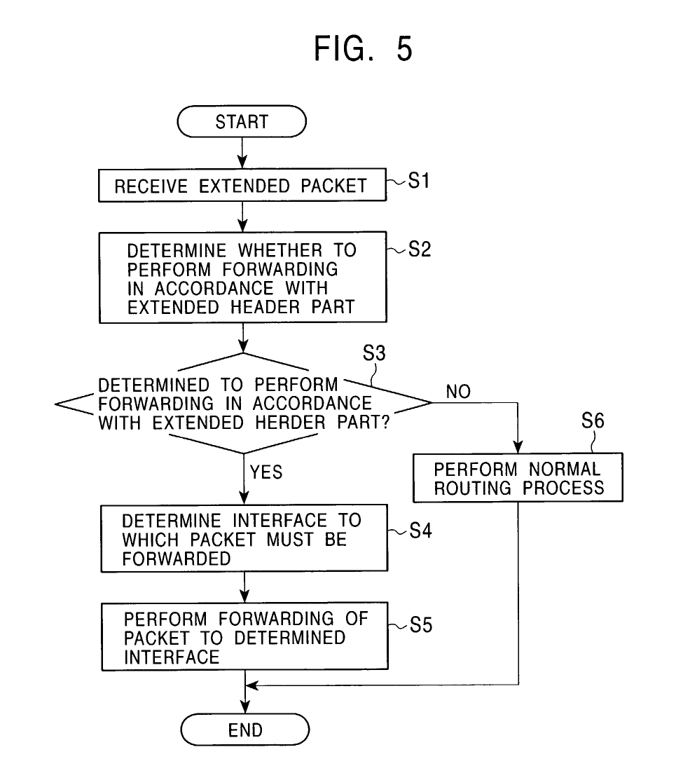

FIG. 5 shows a packet transfer process of the router 1. When the router 1 receives an extended packet (step S1), the packet processing unit 12 determines whether to perform packet forwarding in accordance with the extended header part of the extended packet (step S2). If the packet processing unit 12 has determined to perform packet forwarding in accordance with the extended header part, it determines an interface to which it must forward the packet (step S4), and forwards the packet to the determined interface (step S5) (after producing reproductions of the packet if needed). In step S3, if the packet processing unit 12 has determined not to perform packet forwarding in accordance with the extended header part, it performs a normal routing process (step S6).

By way of example, each of the routers 1 (the boundary router R2 and the internal routers R3 to Rn in the intranet (organization A)) has the following functions.

Even if the SLA ID of the destination address differs from that of the router 1, the router 1 processes an IPv6 packet including an extended header.

When, in the extended header part of the received IPv6 packet, read by the router 1, the packet type represents the extended header (for local broadcasting or multicasting), and the designator designates action, the router 1 compares address-range designating information (e.g., a designated range in the SLA ID field) and the SLA ID of the router 1. If the SLA ID of the router 1 is in the address range designated by the address-range designating information, the router 1 performs packet forwarding to the corresponding interface. If there are a plurality of corresponding interfaces, reproductions of the packet are produced and forwarded.

When the destination address designates a position outside the intranet to which the router 1 belongs, or the designator designates no operation, the router 1 performs the normal routing process. Also, when the designator designates no operation, the router 1 performs the normal routing process. However, even if the designator designates action, a router, positioned on the path used until the extended packet reaches the border router in the intranet, may perform the normal routing process.

Even if the designator designates action, and the SLA ID of the router 1 is in the address range designated by the address-range designating information, when it is found that the corresponding mobile terminal MN1 is not linked to a path (including a case in which another router is used) connecting to the corresponding interface, the packet may not be forwarded to the interface.

Although this embodiment describes cases in which the router 1 changes the content (e.g., the address-range designating information and the designator) of the extended header and in which the extended header is not added to a normal header, the router 1 may have functions of changing the content of the extended header (e.g., changing the address-range designating information, and/or rewriting the designator from no operation to action, and/or rewriting the designator from action to no operation) and of adding the extended header to the normal header, if required.

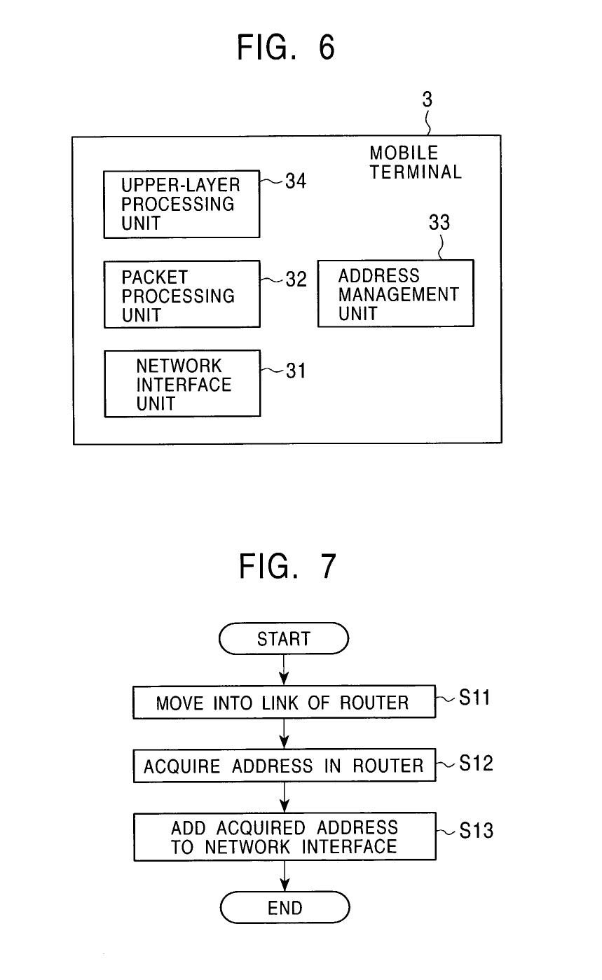

FIG. 6 shows the structure of the mobile terminal 3 in this embodiment. As shown in FIG. 6, the mobile terminal 3 includes a network interface unit 31 having a network interface, a packet processing unit 32 for performing processing for packet communication, and address management unit 33 for performing address management, and an upper-layer processing unit 34 for performing predetermined upper layer processing. The mobile terminal 3 may have other functions and devices, if needed.

In the mobile terminal 3, a plurality of addresses used under the router 1 can be given to the network interface unit 31.

FIG. 7 shows a process in which the mobile terminal 3 performs address acquisition and setting after moving. The mobile terminal 3 moves into a link of a router 1 (step S11). The address management unit 33 acquires an address under the router 1 (if the address has not been acquired) (step S12). The address management unit 33 adds the acquired address to the network interface (step S13).

The mobile terminal 3 finds whether or not the Interface ID of the destination address of the received packet matches that of the mobile terminal 3. When both match, the mobile terminal 3 determines that the packet is addressed to itself, and can transfer the packet to the upper-layer processing unit 34. If the destination address of the received packet matches one of the addresses given to the network interface (even if its prefix differs from that of the address to which the mobile terminal 3 presently belongs), the mobile terminal 3 determines that the packet is addressed to itself and may transfer the packet to the upper-layer processing unit 34.

The mobile terminal 3 is set to enable deletion of the address given to the network interface, if needed, in response to a user's request or on condition that a predetermined deletion condition is satisfied.

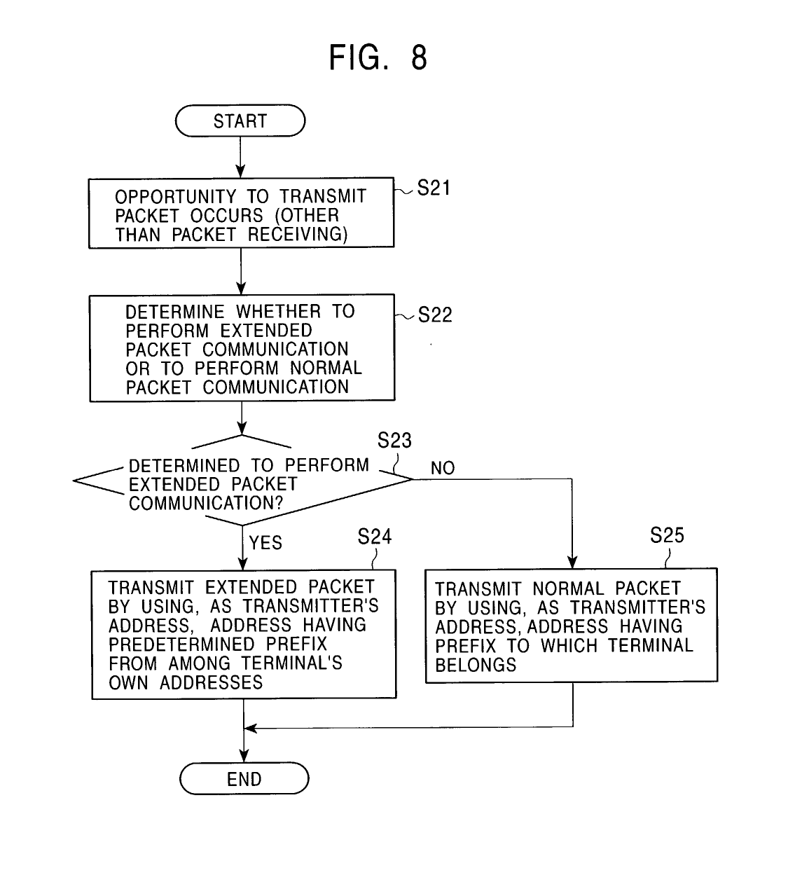

FIG. 8 shows a process performed by the mobile terminal 3 when a packet to be transmitted is generated.

In response to an opportunity other than the generation of a packet to be transmitted for the packet received from another party, for example, in response to a request input by the user, a packet (e.g., a request packet, etc., to the server 7) to be transmitted to the other party is generated (step S21). The mobile terminal 3 determines whether to perform extended packet communication or to perform normal packet communication (step S22).

By way of example, when the mobile terminal 3 has a possibility of moving, or when the mobile terminal 3 has a possibility of moving and needs to perform continuous communication after moving (i.e., a case in which the mobile terminal 3 needs to perform previous address communication after moving), the mobile terminal 3 determines to perform extended packet communication. Also, when the mobile terminal 3 needs to perform continuous communication after moving, it may determine to perform extended packet communication without determining whether it has a possibility of moving.

When the mobile terminal 3 has no possibility of moving, or when the mobile terminal 3 has a possibility of moving and only needs to establish new connection after moving (i.e., a case in which the mobile terminal 3 may perform communication using a new address after moving), the mobile terminal 3 determines to perform normal packet communication. Also, when the mobile terminal 3 only needs to establish new connection after moving, it may determine to perform normal packet communication without determining whether it has a possibility of moving.

The determination may automatically be performed by the mobile terminal 3 in accordance with a predetermined procedure, or may be performed based on determination input by the user after the mobile terminal 3 queries the user.

The possibility of moving is recognized by various methods. For example, in one method, the possibility of moving is recognized in response to an explicit instruction from the user. In another, based on information obtained from a base station or a radio unit, the possibility of moving is recognized. For example, when the address of the mobile terminal 3 changes for each base station, a handoff possibility is detected by comparing radio-wave magnitudes corresponding to base stations, whereby a possibility of address change is detected (However, when the address changes for each group of base stations, the mobile terminal 3 must also detect an address change at a handoff performed based on predetermined identification information included in a message received from a base station). In another, based on information from a timer, the possibility of moving is recognized. For example, when a moving object such as a train moves on a path, and when an automobile or the like moves on an expressway or the like, a time the object or automobile starts at a predetermined starting point is used as a reference time, and a time the address changes is estimated by referring to a correspondence table (time-schedule information) in which correspondences of elapsed times from the reference time, predetermined elapsed times, and addresses are recorded. In another, a possibility of address change is estimated by referring to a correspondence table in which correspondences of positional information (or changing patterns of positional information) obtained by the Global Positioning System (GPS), predetermined positional information, and addresses are recorded.

When the mobile terminal 3 determines to perform extended packet communication (step S23), it transmits an extended packet by using, as the transmitter's address, a predetermined prefix address among the addresses of the mobile terminal 3 (step S24). In the address-range designating information in the option of the extended header, an address range that should be designated assuming that the mobile terminal 3 can move is described (Some addresses in the intranet may be used as the designated range, and all the addresses in the intranet may be used as the designated range). When the network interface has a plurality of addresses, from the addresses, any one (e.g., an address that enables the other party to recognize that the mobile terminal 3 is at the address) (e.g., an address including a prefix to which the mobile terminal 3 belongs, or an address including a prefix to which the mobile terminal 3 belongs before it moves) is selected and used as the transmitter's address. The designator is set to designate no operation.

The address-range designating information is determined in the mobile terminal 3 by various methods. For example, in one method, the determination is performed based on an explicit instruction from the user. In another, the range of addresses to which the mobile terminal 3 can move is estimated when the above possibility of moving is found. This includes a type in which the range of addresses to which the mobile terminal 3 can move is estimated based on information obtained from a base station or a radio unit, a type in which the range of addresses to which the mobile terminal 3 can move is estimated based on information obtained from a timer, and the range of addresses to which the mobile terminal 3 can move is estimated based on positional information obtained by the GPS. In another, the address-range designating information is set beforehand in the entirety of the intranet.

When the mobile terminal 3 determines not to perform extended packet communication (step S23), it transmits a normal packet by using, as the transmitter's address, an address having a prefix to which the mobile terminal 3 presently belongs (step S25).

By using the above method to recognize the possibility of moving, the mobile terminal 3 may transmit an extended packet in order to notify the other party with which the mobile terminal 3 is performing normal packet communication, even if the mobile terminal 3 has no message to be transmitted. For example, the designator of the extended packet is set to represent a specified value other than action and no operation, and packet data is set to be null.

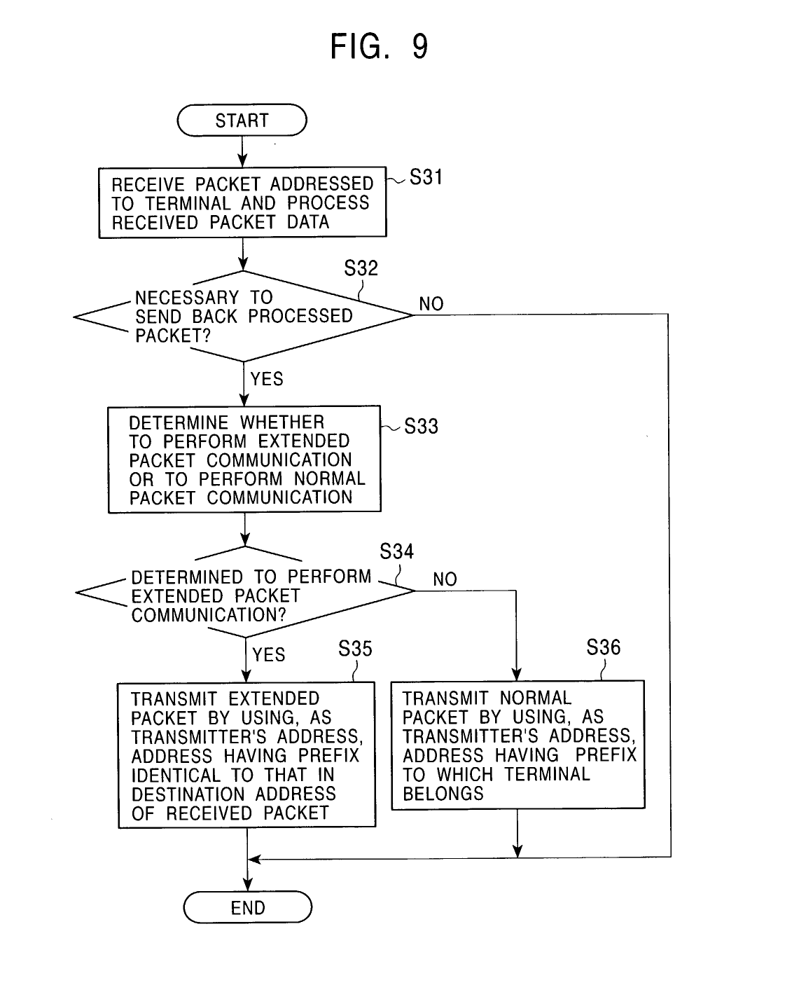

FIG. 9 shows a process of the mobile terminal 3 when it receives a packet.

When the mobile terminal 3 receives a packet addressed to it and processes data carried by the received packet according to necessity (step S31), if it is necessary for the mobile terminal 3 to send back the processed (e.g., a case in which a response packet is generated in response to a predetermined query packet, a case in which a re-send request packet is generated in response to a predetermined response packet, etc.) (step S32), the mobile terminal 3 determines whether to perform extended packet communication or to perform number of contents (step S33). For example, when the mobile terminal 3 transmits a packet in response to an extended packet including an action designator, when the mobile terminal 3 transmits a packet in response to an extended packet including an action designator, has a possibility of moving, and needs to perform continuous communication even after moving, or when the mobile terminal 3 transmits a packet in response to a normal packet, has a possibility of moving, and needs to perform continuous communication even after moving, the mobile terminal 3 determines to perform extended packet communication. Also, for example, when the mobile terminal 3 transmits a packet in response to a normal packet, and has no possibility of moving, or only needs to establish new connection even after moving, or when the mobile terminal 3 transmits a packet in response to an extended packet including an action designator, is positioned at the present address used in the extended packet, and does not further move or needs to establish new connection even after moving, the mobile terminal 3 determines to perform normal packet communication. The determination may automatically be performed by the mobile terminal 3 in accordance with a predetermined procedure, or may be performed based on a determination input by the user after the mobile terminal 3 queries the user.

The determination of the possibility of moving is as described above.

When the mobile terminal 3 determines to perform extended packet communication (step S34), it transmits an extended packet by using, as the transmitter's address, one of the addresses of the mobile terminal 3 which has a prefix identical to that of the destination address of the received packet (step S35). Although the address-range designating information in the option field of the extended header may be identical to that in the received packet, it may be changed as required. The designator is set to designate no operation.

When the mobile terminal 3 determines not to perform extended packet communication (step S34), it transmits a normal packet by using, as the transmitter's address, an optimal address for the subnetwork to which it presently belongs, that is, an address having a prefix to which it presently belongs (step S36).

By performing these steps, even if the mobile terminal 3 moves to one of the links in an intranet (e.g., the organization A in FIG. 1), it can receive a packet from the other party without failure (see reference numeral 300 in FIG. 16), and can perform communication with the other party by using the same transmitter's address.

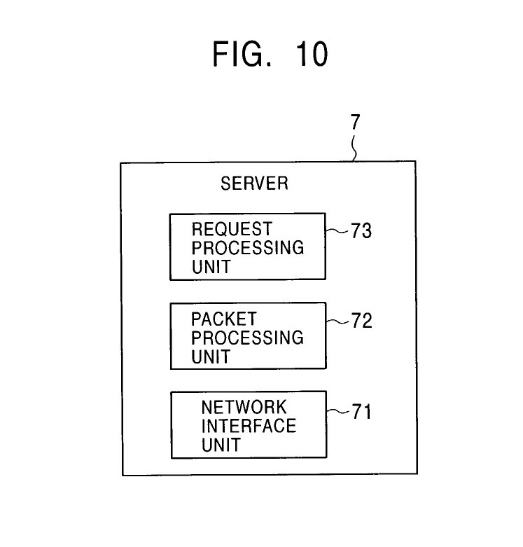

FIG. 10 shows the structure of the server 7 as another party with which the mobile terminal 3 communicates. As shown in FIG. 10, the server 7 includes a network interface unit 71 having a network interface, a packet processing unit 72 for performing processing for packet communication, and a request processing unit 73 for processing a predetermined request given from a node as a request source. The server 7 may have other functions and devices, if needed.

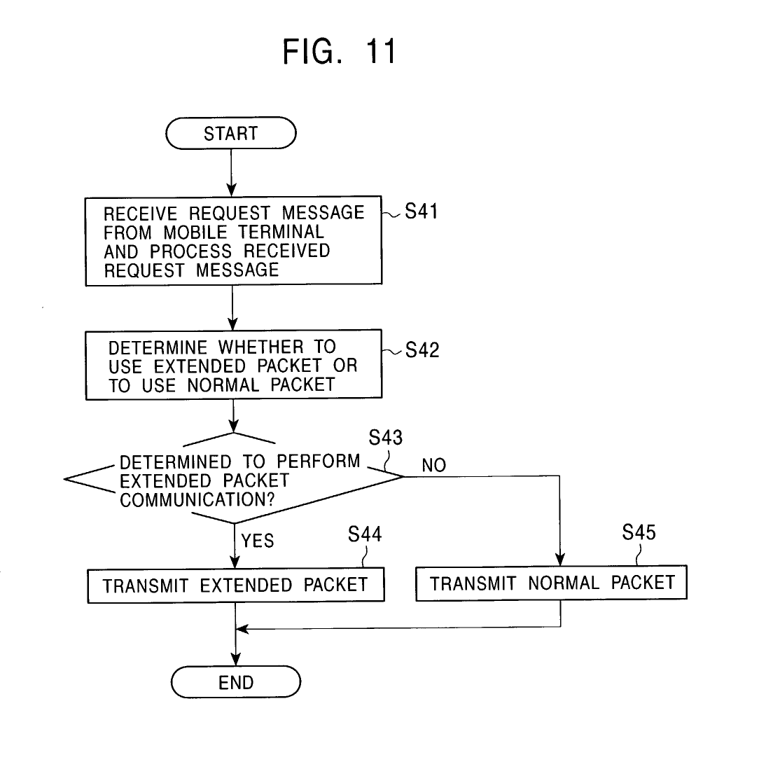

FIG. 11 shows a process performed by the server 7 when it receives a request. When the server 7 receives a request message from the mobile terminal 3, it processes the received request message (step S41). The server 7 determines whether to use an extended packet or whether to a normal packet (step S42). In step S42, when the request message is received in an extended packet form, the server 7 determines to send a response message in the extended packet form, while when the request message is received in a normal packet form, the server 7 determines to send a response message in the normal packet form.

When the server 7 determines to perform extended packet communication (step S43), it transmits an extended packet in which the destination address of the received packet is used as a transmitter's address, the transmitter's address of the received packet is used as a destination address, address-range designating information is identical to that described in the option field of the extended header of the received packet, and a designator is set to designate action (step S45).

When the server 7 determines not to perform extended packet communication (step S43), it transmits a normal packet as a response message (step S45).

Next, a case is described below in which a predetermined message (e.g., a predetermined request message or notification message) other than a response message is transmitted from the other party (which may be one of another mobile terminal 3, the router 1, and some other node) with which the mobile terminal 3 communicates to the mobile terminal 3.

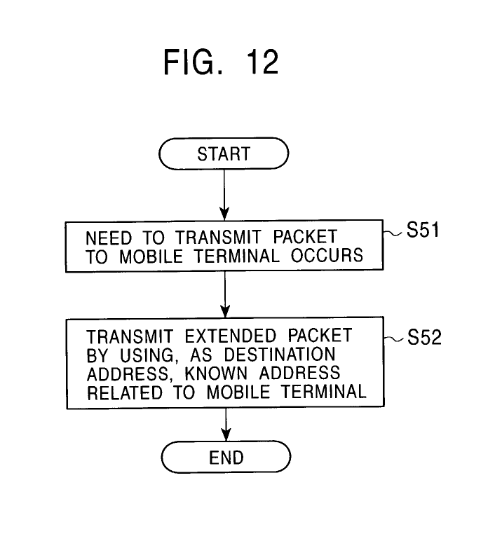

FIG. 12 shows a process in which, when one other party knows address-range designating information on one mobile terminal 3 (e.g., when the server 7 receives a request message in an extended packet form from the mobile terminal 3), the other party transmits a message in an extended packet form to the mobile terminal 3. Specifically, when the other party has the need to transmit a packet to the mobile terminal 3 (step S51), it transmits a predetermined message in which an address recognized by it on the mobile terminal 3 is used as a destination address, its own address is used as a transmitter's address, address-range designating information is set identically to that (e.g., that described in the last extended packet received from the mobile terminal 3) posted by the mobile terminal 3, and a designator is set to designate action (step S52).

In step S52, the predetermined message is transmitted in the extended packet form. However, there is also a method in which, after using a probe packet (a packet for querying about the present address) to acquire the present address of the mobile terminal 3, the predetermined message is transmitted in a normal packet form.

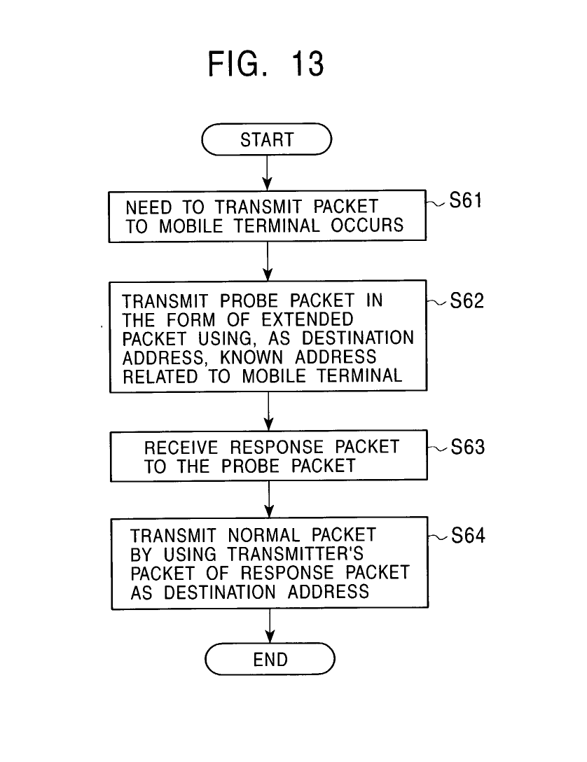

FIG. 13 shows an example of a process performed in the above case. When the other party has the need to transmit a packet to the mobile terminal 3 (step S61), it transmits a probe packet in the form of an extended packet in which an address recognized by it on the mobile terminal 3 is used as a destination address, its own address is used as a transmitter's address, and address-range designating information is set identically to that (e.g., that described in the last extended packet received from the mobile terminal 3) posted by the mobile terminal 3 (step S62).

Regarding the probe packet, there are various methods including a type in which the packet type is set identically to that in an extended packet for local broadcasting or multicasting, and a designator is set to designate a probe, and a type in which the packet type for broadcasting is separately defined.

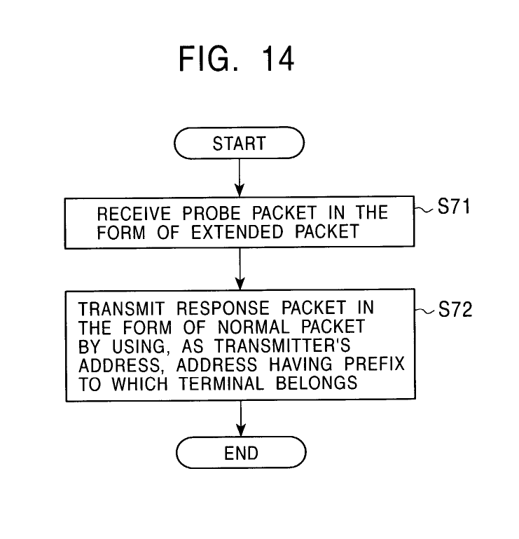

FIG. 14 shows a process performed by the mobile terminal 3 when it receives the probe packet. When the mobile terminal 3 receives the probe packet from the other party (step S71), it transmits a response packet in the form of a normal packet in which an address having a prefix to which it belongs is used as a transmitter's address (step S72).

When the other party receives the response packet to the probe packet (step S63), it transmits a predetermined message in the form of a normal packet in which an address (acquired by the response packet) having a prefix to which the mobile terminal 3 presently belongs (step S64).

A case in which a mobile terminal MN1 and a sever S1 communicate with each other is described below with reference to FIGS. 15 to 17.

When the mobile terminal MN1 which is positioned under the router R3 has a possibility of moving, it transmits, to the server S1, a request message in the form of an extended packet in which a transmitter's address is MN1_addr@R3, a destination address is S1_addr, the address-range designating information in the option field of the extended header is set to represent all the addresses in the intranet (having a router R2 as a boundary router) and a designator is set to designate no operation (see reference numeral 100 in FIG. 15).

Next, the mobile terminal MN1 moves under a router R4, acquires MN1_addr@R4, and adds the acquired address to its own network interface (see reference numeral 200 in FIG. 15).

When receiving the request message in the extended packet form, the server S1 processes the request, and transmits a request message in the form of an extended packet in which a transmitter's address is S1_addr, a destination address is MN1_addr@R3, address-range designating information is set identically to that described in the extended header of the request message (see reference numeral 300 in FIG. 16).

When receiving the extended packet, the router R2 reads the extended header, and forwards, based on the address-range designating information in the extended header, the extended packet to a network interface of the router R2 which corresponds the range (see reference numeral 300 in FIG. 16). For forwarding, the router R2 produces reproductions of the packet, as required. In the case in FIG. 16, it is determined that the packet transfer to all the lower-level internal routers R3 to Rn is performed, and packets addressed to MN1_addr@R1 are cast to the routers R3 to Rn.

When receiving the extended packet, based on the address-range designating information in the extended header, each of the routers R3 to Rn forwards the extended packet (or reproductions thereof, if needed) to a network interface of the router which corresponds to the range (see reference numeral 300 in FIG. 16). In this case, it is determined that packets are transferred to all leaves, and packets addressed to MN1_addr@R1 are cast to the leaves, respectively.

The mobile terminal MN1 under the router R4 receives the extended packet which is transferred through the path from the router R2 to R4, and recognizes that the response message is addressed to the mobile terminal MN1 when the Interface_ID in the destination address of the received packet matches the Interface_ID of the mobile terminal MN1. Then, the mobile terminal MN1 processes the message (see reference numeral 300 in FIG. 16).

When the mobile terminal MN1 under the router R4 uses the address MN1_addr@R4 (on the router R4) to establish new connection, it can communicate with the server S1 by using a normal packet using the address MN1_addr@R4 (see reference numerals 400 and 500 in FIG. 17).

Next, a case in which the server S1 uses a probe packet is described below.

Similarly to the above description, the mobile terminal MN1 transmits a request message to the server S1 in the form of an extended packet (see reference numeral 100 in FIG. 15), and moves under the router R4 (see reference numeral 200 in FIG. 15).

When receiving the request message in the extended packet, the server S1 processes the request. After that, before transmitting a response message, the server S1 transmits a probe packet in which a transmitter's address is S1_addr, a destination address is MN1_addr@R3, address-range designating information is set identically to that described in the extended header of the request message (see reference numeral 300 in FIG. 16).

When receiving the extended packet, based on the address-range designating information in the extended header, each of routers R2 to Rn forwards the received packet (or reproductions thereof if needed) to a network interface of the router which corresponds to the address range (see reference numeral 300 in FIG. 16).

The mobile terminal MN1, which is positioned under the router R4, receives the probe packet transferred through the path from the router R2 to R4 (see reference numeral 300 in FIG. 16).

In response to the probe packet, the mobile terminal MN1 transmits a response message in the form of a normal packet in which the present address MN1_addr@R4 of the mobile terminal MN1 is used as a transmitter's address, and S1_addr is a destination address (see reference numeral 400 in FIG. 17).

After receiving the response message, the server S1 transmits a response message to the request message by using a normal packet in which a transmitter's address is S1_addr and a destination address is MN1_addr@R3 (see reference numeral 500 in FIG. 17).

After that, the mobile terminal MN1 may communicate with the server S1 by using a normal packet. If the mobile terminal MN1 has a possibility of moving, it may perform extended packet communication.

Next, a mobile agent to which the present invention is applied is described below.

A mobile agent is a program that executes a requested process (e.g., the operation of retrieving and collecting information which satisfies retrieval conditions designated by a user of a requesting computer) by moving or browsing through a plurality of computers in accordance with a plan. For example, a mobile agent moves from a requesting terminal to a certain server A (e.g., a data management server), and performs retrieval in the server A. The mobile agent moves to the next server B with the result of the retrieval, and performs retrieval in the server B. The mobile agent moves to the final server C with the results of the retrieval, performs retrieval in the server C, and returns to the requesting terminal with all the results of retrieval in the servers A to C.

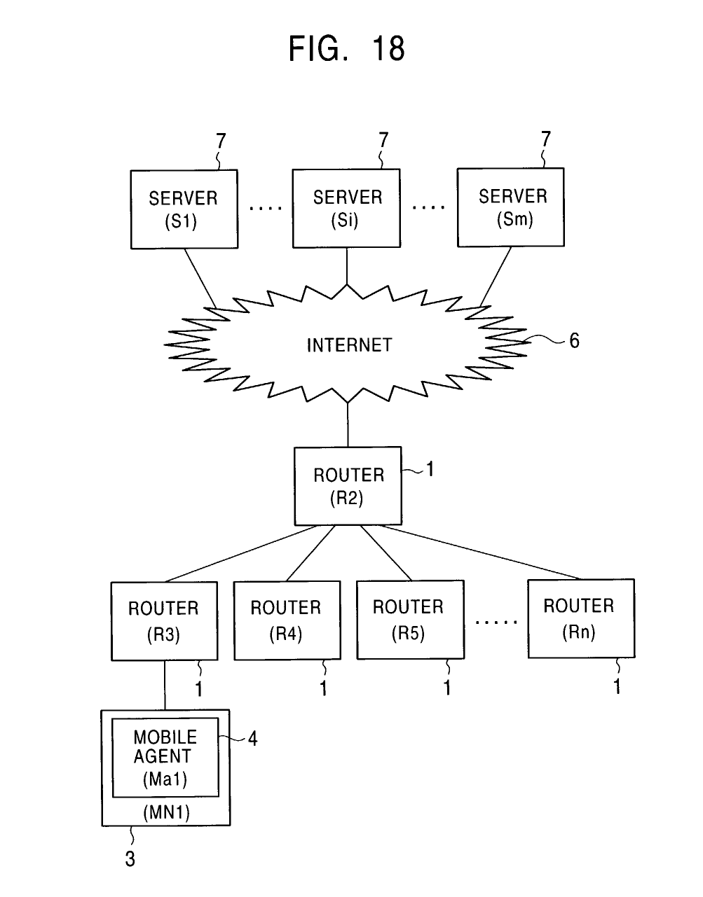

FIG. 18 shows an example of a system configuration in the case of using a mobile agent.

In this system configuration, a case is described in which a mobile agent 4 (Ma1) browses from a mobile terminal 3 (MN1) through a plurality of servers 7 (S1, . . . , Si, . . . , Sm) and returns to the mobile terminal 3 (MN1), while the mobile agent 4 moves between routers 2 (R3 and R5).

An apparatus (e.g., the mobile terminal 3, the server 7) that executes the mobile agent 4 has a function (e.g., a mobile agent platform as a type of virtual machine) for executing the mobile agent 4 as software.

The server 7 in this case may have or may not have the functions that have been described. In the latter case, the mobile agent 4 must have the functions that have been described.

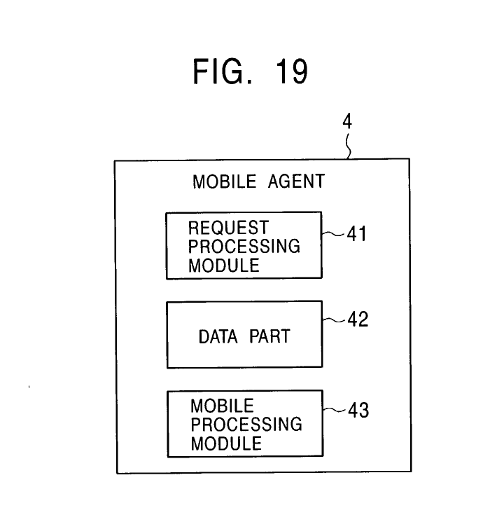

FIG. 19 shows the structure of the mobile agent 4. As shown in FIG. 19, the mobile agent 4 includes a request processing module 41 for processing a request, a data part 42 for storing data for use in request processing, data of the result of request processing, etc., and a mobile processing module 43 for performing processing for moving the mobile agent 4. Processing related to the extended packet is performed by the mobile processing module 43. The mobile agent 4 may include other modules, as required.

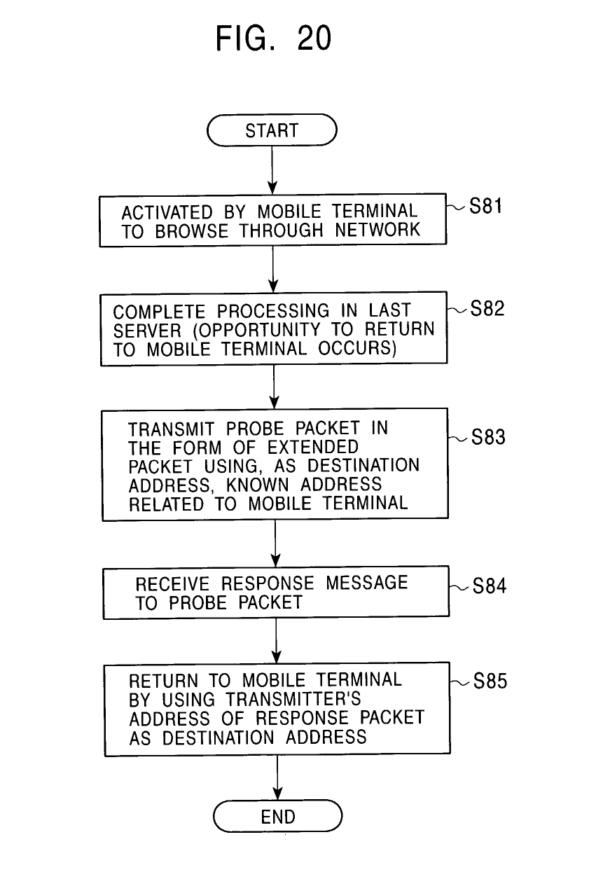

FIG. 20 shows an example of a process performed by the mobile agent 4.

Since the mobile terminal MN1 is positioned under the router R3 in this example, it has at least the address MN1_addr@R3.

When being activated in the mobile terminal MN1, which makes a request, the mobile agent Ma1 browses through the network (step S81).

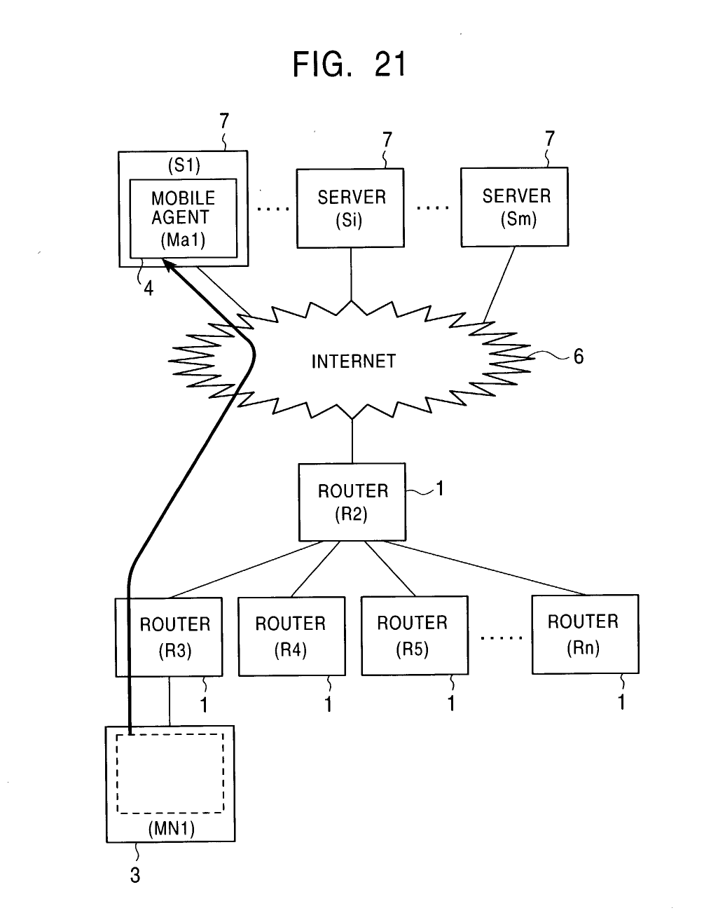

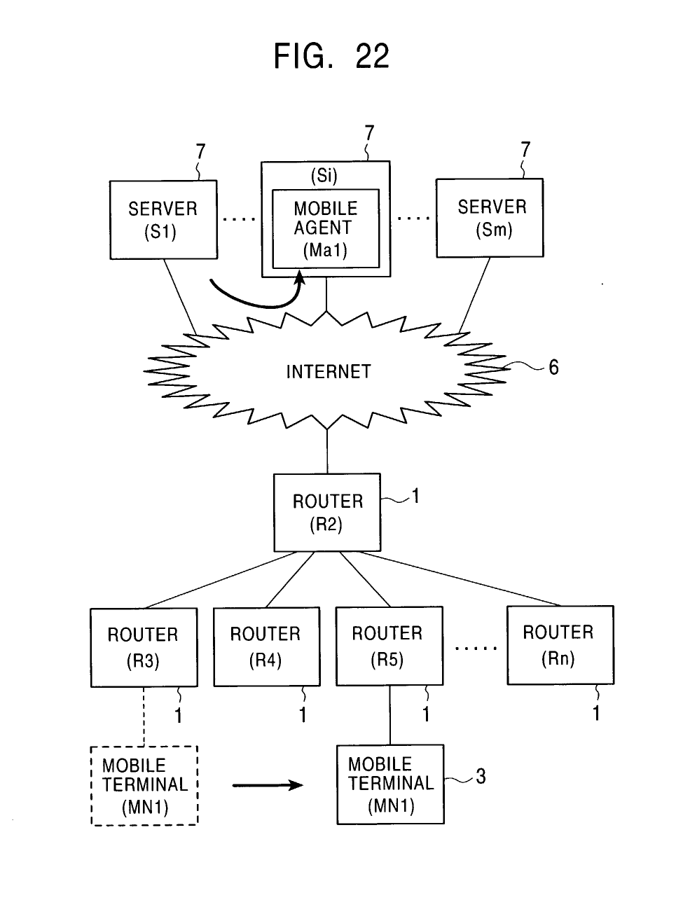

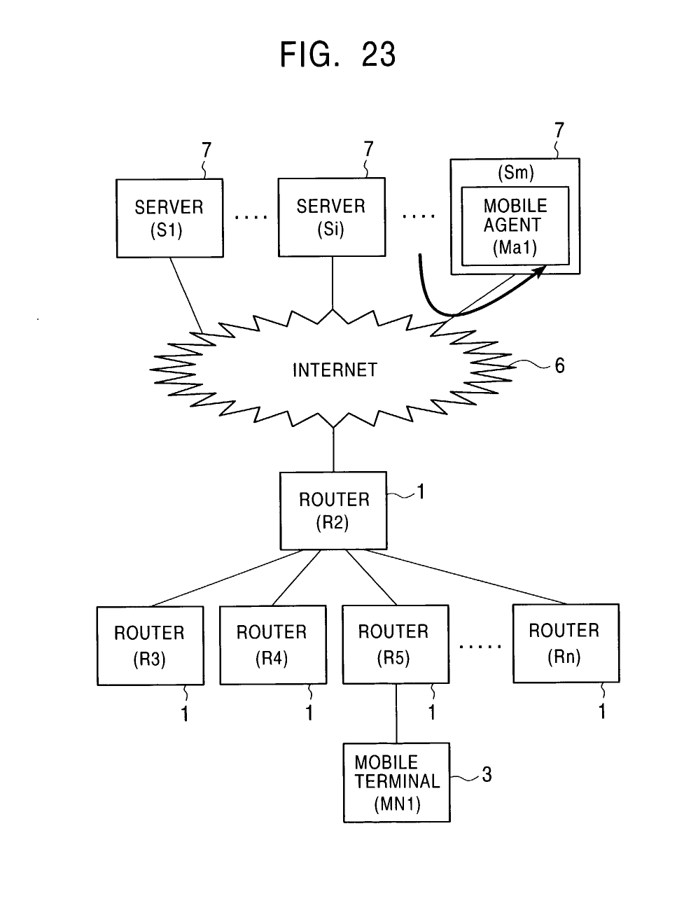

By way of example, as FIGS. 21 to 23 show, the mobile agent Ma1 is activated in the mobile terminal MN1 and is sent to a server S1. After moving to the server S1, the mobile agent Ma1 performs a requested process (e.g., information retrieval). Next, the mobile agent Ma1 moves and performs a requested process in the server S2. Similarly, the mobile agent Ma1 moves and performs a requested process in the server Si. This is repeatedly performed. Finally, the mobile agent Ma1 moves and performs a requested process in the server Sm. For the moving in this case, a normal packet including the mobile agent 4 (software) may be transferred from a starting point (e.g., the mobile terminal MN1) of the mobile agent 4 to a destination point (e.g., the server S1). However, an extended packet including a no-operation designator can also be used.

For returning to the mobile terminal MN1 as the request sender, the mobile agent Ma1 must move while retaining the IPv6 address of the mobile terminal MN1 and address-range designating information to be described in the extended header. The IPv6 address of the mobile terminal MN1 may be the address MN1_addr@R3 having a prefix with which the mobile terminal MN1 belongs. Also, the IPv6 address may be a present address of the mobile terminal 3 which has another prefix, or an address (e.g., MN1_addr@R5) that will be acquired after the mobile agent Ma1 moves. In this example, MN1_addr@R3 is retained.

In addition, while the mobile agent Ma1 browses through the network, the mobile terminal MN1 as the request sender moves in the intranet (organization A). For example, as shown in FIGS. 21 to 23, the mobile terminal MN1 moves from the router R3 to R5. Here, the mobile terminal MN1 acquires the address MN1_addr@R5 under the router R5. The mobile terminal MN1 must have at least the addresses MN1_addr@R3 and MN1_addr@R5.

When completing the request process in the last server Sm, the mobile agent Ma1 enters a procedure for returning to the mobile terminal MN1 as the request sender (step S82).

Before returning to the mobile terminal MN1 as the request sender, the mobile agent Ma1 transmits (through the server Sm) a probe packet in which the address MN1_addr@R3 of the mobile terminal MN1, which is internally retained in the mobile agent Ma1, is used as a destination address, the address of the server Sm is used as a transmitter's address, address-range designating information is set identically to that retained in the mobile agent Ma1 (step S83).

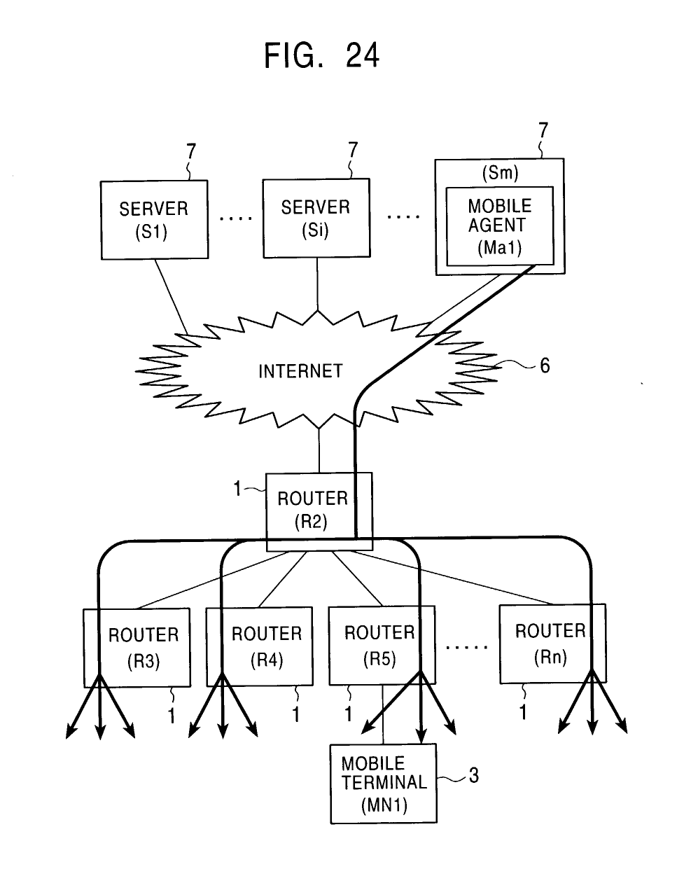

After receiving the extended packet, based on the address-range designating information in the extended header, the router R2 forwards the packet (or reproductions thereof if needed) to a network interface of the router R2 which corresponds the range. In this case, as FIG. 24 shows, it is determined that packet transfer to all the lower level routers R3 to Rn is performed, and packets addressed to the address MN1_addr@R1 are cast to the routers R3 to Rn.

After receiving the extended packet from the boundary router R2, based on the address-range designating information in the extended header, each of the internal routers R3 to Rn forwards (or reproductions thereof if needed) the extended packet to a network interface of the router which corresponds to the range. In this case, as shown in FIG. 24, it is determined that packet transfer to all the leaves is performed, and packets addressed to the address MN1_addr@R1 are cast to all the leaves.

The mobile terminal MN1, which is positioned under the router R4, receives the probe packet transferred through the path from the router R2 to R5. For example, the mobile terminal MN1 recognizes that the transferred probe packet is addressed to itself because the destination address Interface_ID of the probe packet matches the Interface_ID of the mobile terminal MN1.

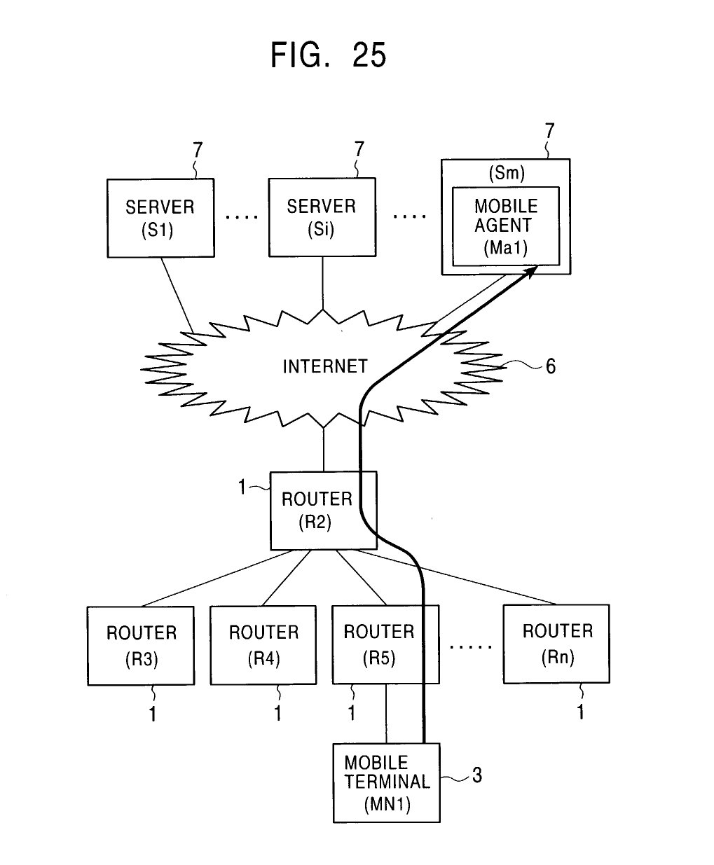

As FIG. 25 shows, in response to the probe packet, the mobile terminal MN1 transmits a response message in the form of a normal packet in which the present address of the mobile terminal MN1 is used as a transmitter's address and Sm_addr is used as a destination address.

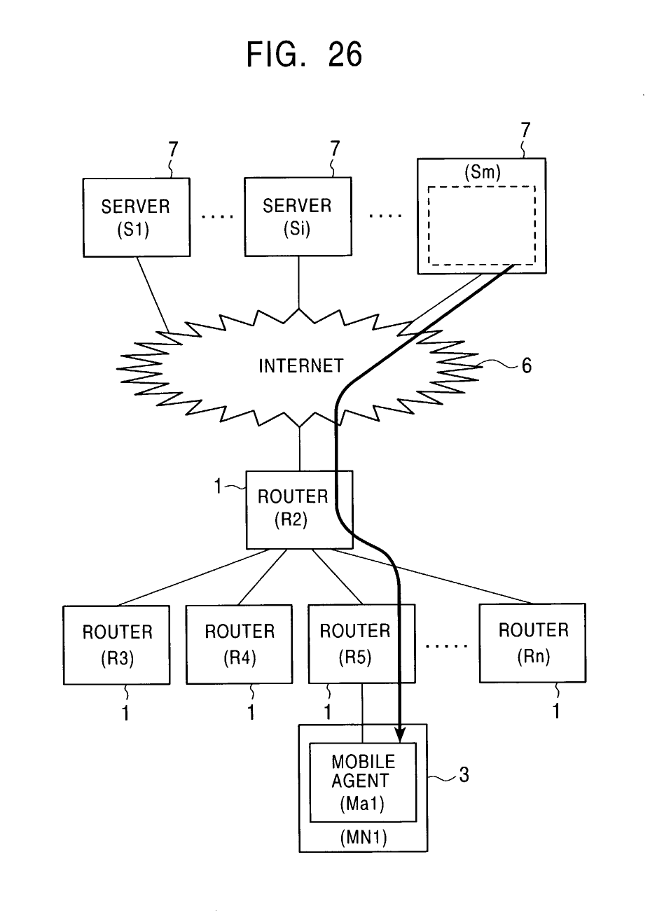

When receiving the response message (through the server Sm) (step S84), the mobile agent Ma1 finds the present address MN1_addr@R5 of the mobile terminal MN1. Thus, as FIG. 26 shows, the mobile agent Ma1 can return to the mobile terminal MN1 in the form of a packet in which a transmitter's address is Sm_addr and a destination address is MN1_addr@R5.

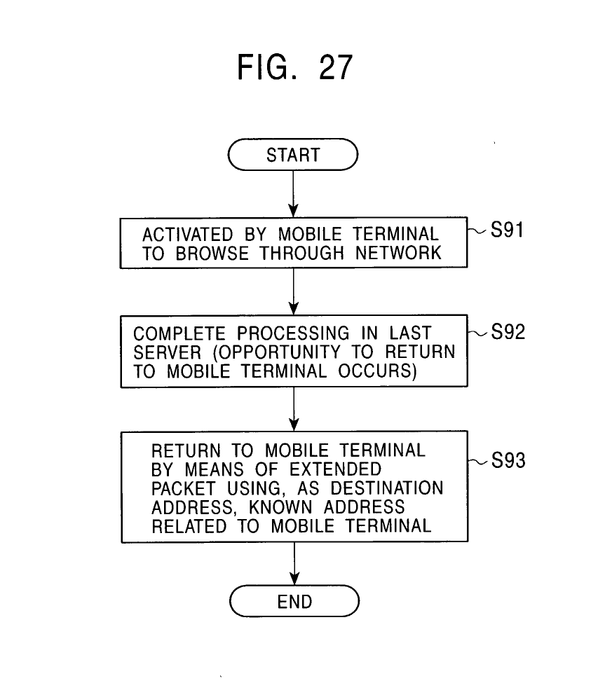

Next, FIG. 27 shows another process performed by the mobile agent 4.

The flow (steps S91 and S92 and FIGS. 21 to 23) of the process from the activation of the mobile agent Ma1 in the mobile terminal MN1 as a request sender up to the return to the mobile terminal MN1 on completion of the request processing is similar to that in the above-described example.

In the process in FIG. 27, the mobile agent Ma1 returns to the mobile terminal MN1 by using an extended packet in which the address MN1_addr@R3 of the mobile terminal MN1, which is internally retained in the mobile agent Ma1, is used as a destination address, the address Sm_addr of the server is used as a transmitter's address, and address-range designating information is set identically to that retained in the mobile agent Ma1. In other words, an extended packet including the mobile agent Ma1 (software) is transmitted (step S93).

After receiving the extended packet including the mobile agent Ma1, based on the address-range designating information of the extended header, each of the routers R2 to Rn forwards the extended packet (or reproductions thereof) to a network interface of the router which corresponds to the address range.

Among the packets, those transferred through the path from the router R2 to R5 is received by the mobile terminal MN1, which is under the router R5, whereby the mobile agent Ma1 can directly return to the mobile terminal MN1 (without probing the address of the mobile terminal MN1).

As described above, even if the mobile terminal MN1 moves while the mobile agent Ma1 is browsing through the network, the mobile agent Ma1 can return to the mobile terminal MN1.

In the above method, for returning to the mobile terminal MN1, the mobile agent Ma1 moves while retaining the address-range designating information to be described in the extended header. However, it is not necessary for the mobile agent Ma1 to move while retaining the address-range designating information, but the address-range designating information in the extended header may be set to indicate that it is valid in the SLA of the intranet (organization A).

In addition, in the case of employing a construction in which, only when the mobile agent Ma1 transmits a probe packet to the mobile terminal MN1 or returns to the mobile terminal MN1 does it use an extended packet, it is not necessary to provide the designator (this is identical to the case of setting the designator to always designate action).

Next, a case in which a mobile terminal moves after casting a multicast packet or a unicast packet in a single intranet is described below.

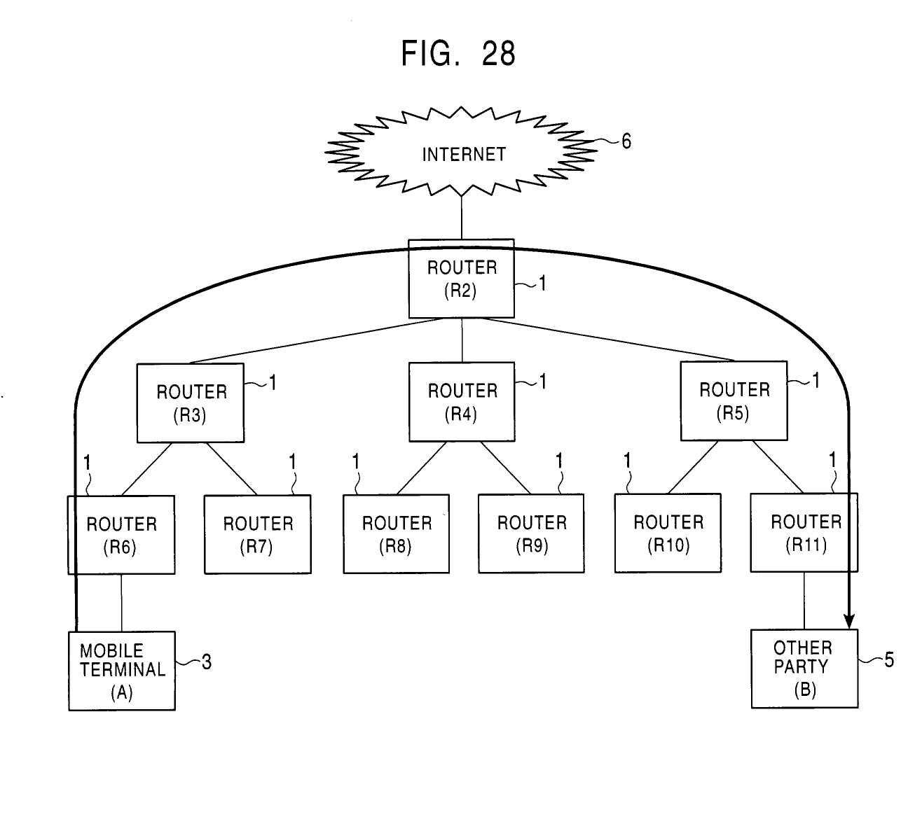

FIG. 28 shows an example of a network configuration for the above case. As shown in FIG. 28, the configuration has a boundary router R2 in the boundary of this network, routers R3 to R5 at a level lower than the boundary router R2, routers R6 and R7 under the router R3, routers R8 and R9 under the router R4, and routers R10 and R11 under the router R5.

A mobile terminal A (3) is connected to the router R6, and its address is A_addr@R6. Another party (node) B (5) with which the mobile terminal A communicates is connected to the router R11, and its address is B_addr@R1.

As shown in FIG. 28, when the mobile terminal A transmits a packet to a multicast address/unicast address B, in order for the receiver side to use an extended packet, the mobile terminal A transmits an extended packet in which a transmitter's address is A_addr@R6, a destination address is B_addr@R11, address-range designating information in the option field of the extended header is set to represent the entirety of the organization (intranet) to which the mobile terminal A belongs, a designator is set to designate no operation.

The routers R6, R3, R5, and R11, which relay the extended packet, perform normal routing on the extended packet.

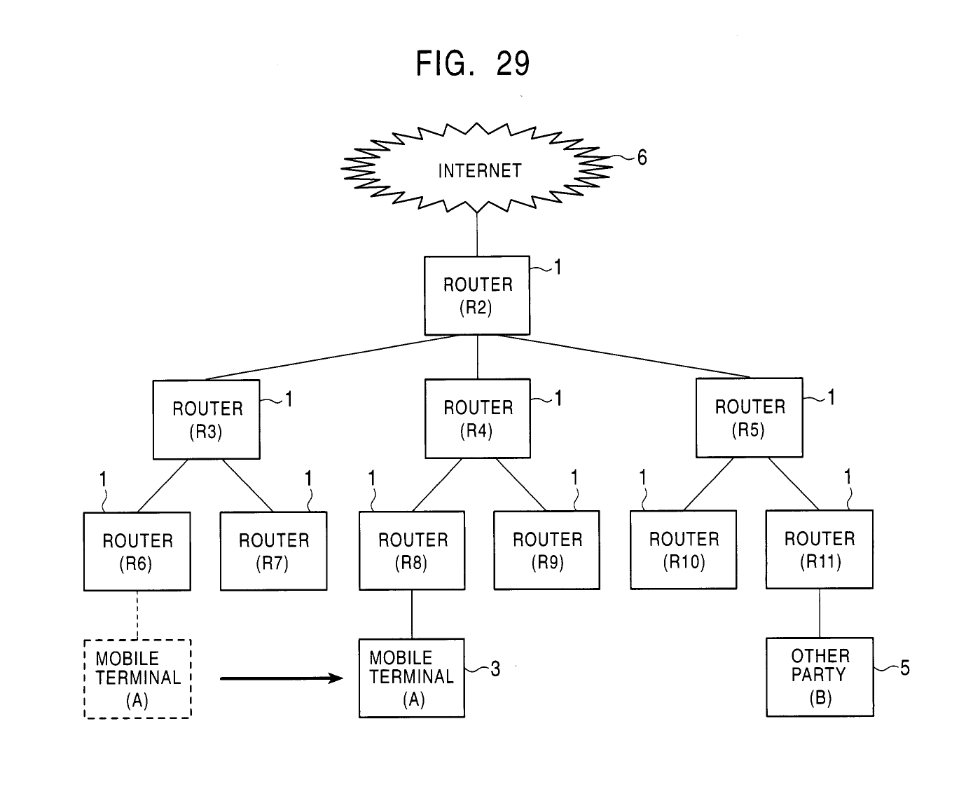

After that, as FIG. 29 shows, the mobile terminal A moves under the router R8. In this position, the mobile terminal A has at least the addresses A_addr@R6 and A_addr@R8.

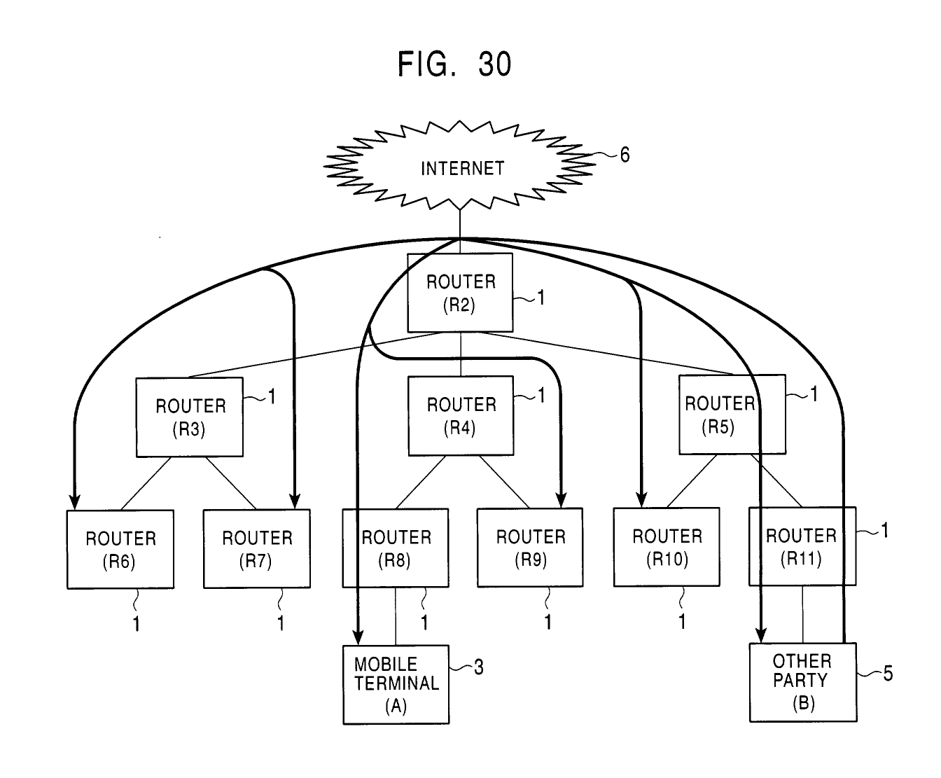

Next, as FIG. 30 shows, the other party B rewrites the no-operation designator in the extended header of the extended packet to designate action, and responds to the mobile terminal A. The destination address for the response is the address A_addr@R6 which is under the router R6. After reading the extended header, based on the value of the SLA of the router and the value of the SLA represented by the address-range designating information in the extended header, each router determines whether to transfer the packet to each lower level router. Packet transfer is performed based on the determination. In this case, as shown in FIG. 30, the packet is transferred over the entire intranet. The response packet transferred from the other party B through the routers R2, R4, and R8 can be received by the mobile terminal A, which has moved under the router R8.

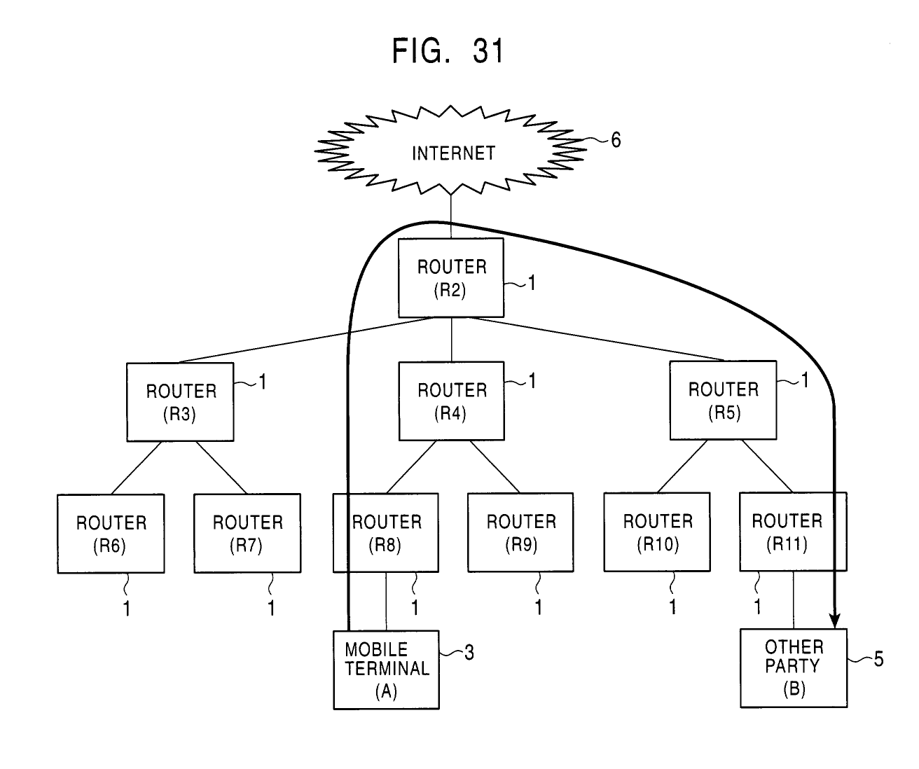

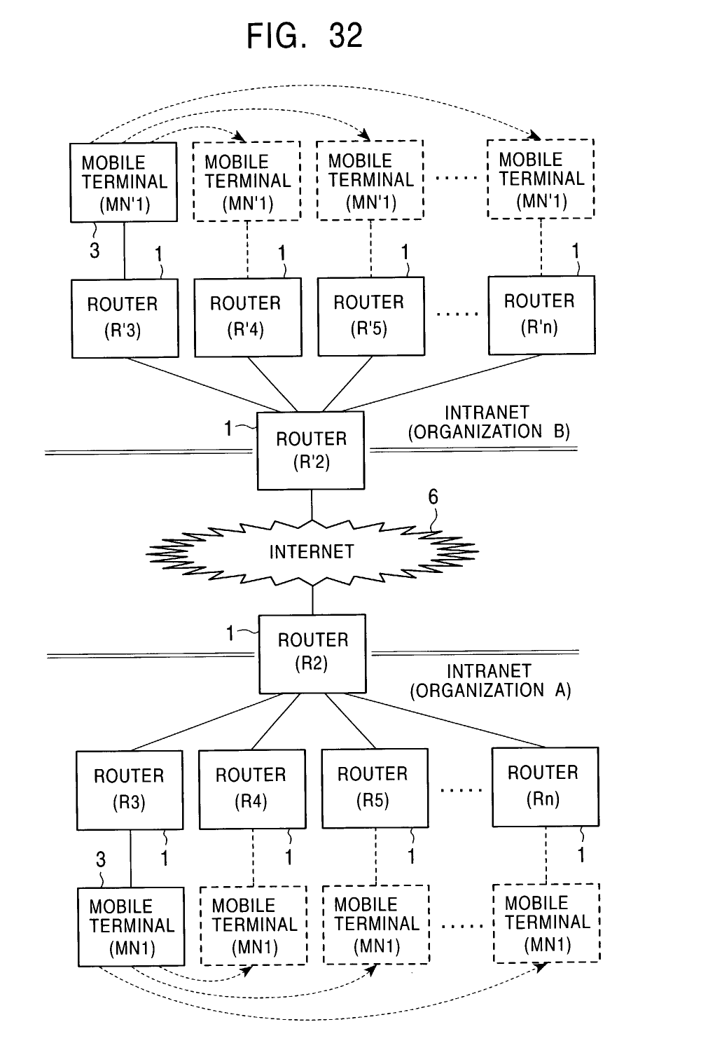

As FIG. 31 shows, when a continuous link to the other party B is needed, communication with the other party B is performed by using an extended header in which the address A_addr@R6 used under the router R6 is used as a transmitter's address. However, when new communication is initiated, communication is performed by using a normal header in which the address A_addr@R8 under the router R8 is used as a transmitter's address.

In the above description, if a mobile terminal has already transmitted an extended packet (of a packet type representing an extended header for local broadcasting or multicasting) to another party, when the mobile terminal transmits an extended packet including a no-operation designator thereafter, it adds address-range designating information for transmission. However, when the other party already knows the address-range designating information, there is also a method that transmits an extended packet in which the address-range designating information is omitted and the designator is set to designate no operation. Alternatively, instead of transmitting an extended packet (of a packet type representing an extended header for local broadcasting or multicasting) including a no-operation designator, there is also a method that transmits an extended packet including an extended header of another packet type indicating that an extended packet (of a packet type representing an extended header for local broadcasting or multicasting) including an action designator must be used as a response packet to the received packet for the other party. In these cases, the other party may respond with an extended packet including an action designator by using, for example, the last address-range designating information posted from the mobile terminal.

Although, in the description, it is assumed that the other party does not move, it is possible that two nodes which communicate with each other move. Such a case is described below.

FIG. 32 shows an example of a network system for this case.

As shown in FIG. 32, a first intranet (organization A) and a second intranet (organization B) are linked to the Internet 6, and there are boundary routers R2 and R′2 in the boundaries between the intranets and the Internet 6. Other routers R3 to Rn are internally linked to the router R2, and other routers R′3 to R′n are internally linked to the router R′2.

Inside the intranet (organization A), there is a mobile terminal MN1, and inside the intranet (organization B), there is a mobile terminal MN′1. A case in which the mobile terminal MN1 in the intranet (organization A) and the mobile terminal MN′1 in the intranet (organization B) communicate with each other is described below.

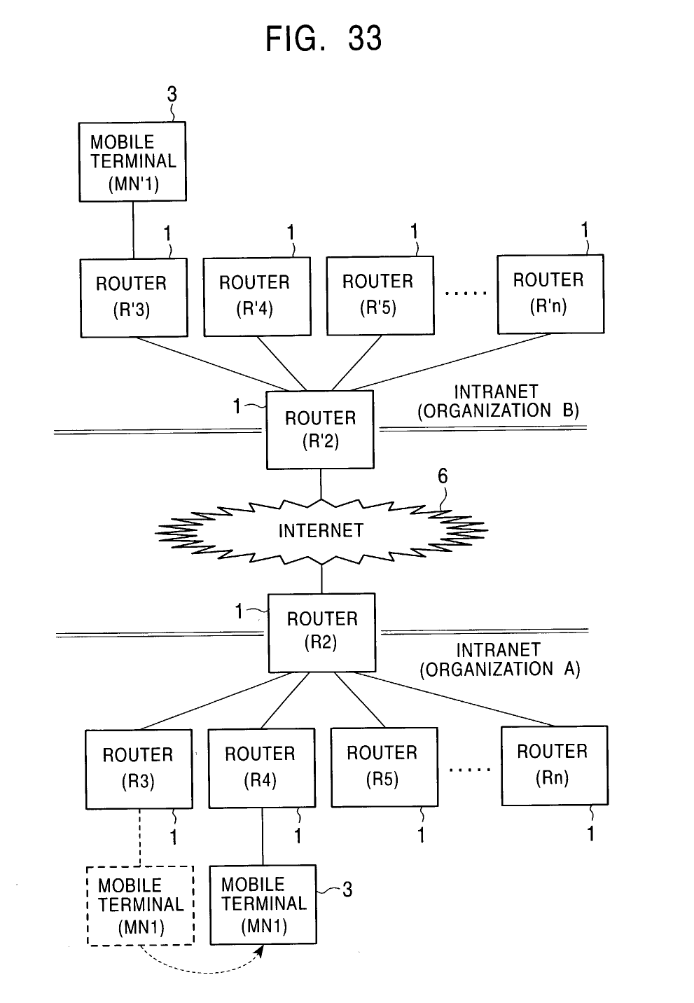

As FIG. 33 shows, while the mobile terminal MN′1 has no possibility of moving in the intranet (organization B) although the mobile terminal MN1 moves in the intranet (organization A), or in a case in which, if the mobile terminal MN′1 moves, it only needs to establish new connection after moving, by transmitting, from the mobile terminal MN′1 (in the intranet (organization B)) to the mobile terminal MN1 (in the intranet (organization A)), an extended packet including an action designator, communication can be performed.

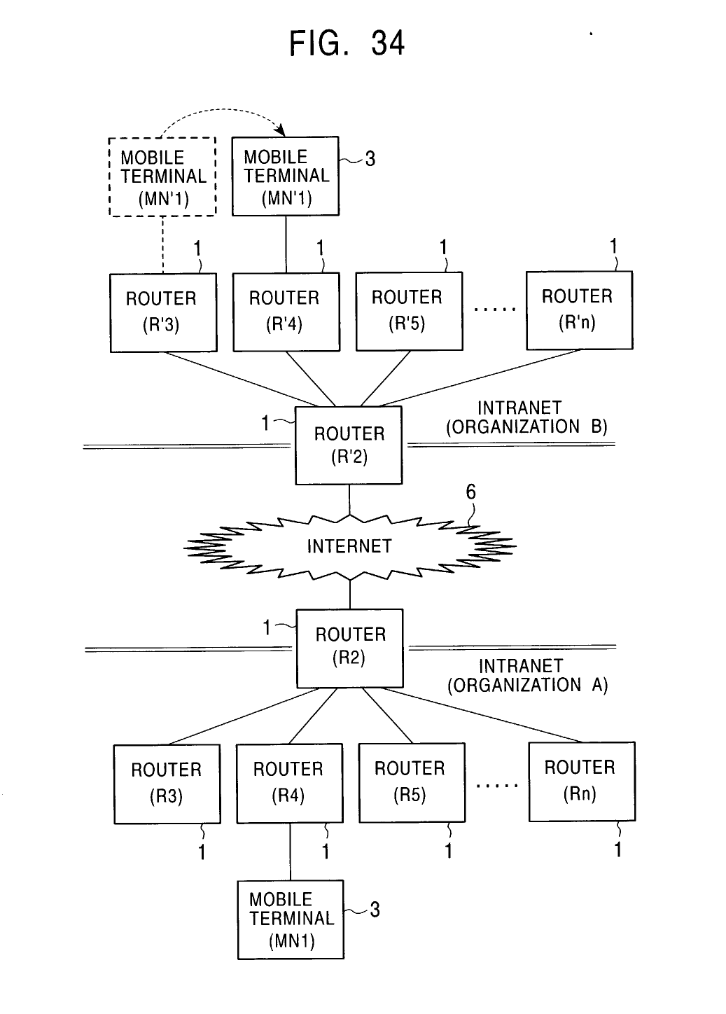

From this state in FIG. 33, as FIG. 34 shows, if the mobile terminal MN′1 moves in the intranet (organization B), no packet reaches the mobile terminal MN′1 in the intranet (organization B) from the mobile terminal MN1 in the intranet (organization A).

Accordingly, when the mobile terminal MN′1 in the intranet (organization B) has a possibility of moving, or it has a possibility of moving and needs to perform continuous communication, an extended packet including an action designator may be transmitted from the mobile terminal MN1 (intranet (organization A)) also to the mobile terminal MN′1 intranet (organization B).

In this case, two extended headers may be added as an extended packet related to a terminal on the destination address side and as an extended packet related to a terminal on the transmitter's address side. In the option field in the extended header, it is only necessary to write a flag indicating that it is related to a terminal on the destination address side of the normal header or that it is related to a terminal on the transmitter's address side of the normal header.

By way of example, in the case of transmitting an extended packet from the mobile terminal MN′1 in the intranet (organization B) which has a possibility of moving to the mobile terminal MN1 in the intranet (organization A), by setting a normal header to have the destination address MN1_addr@R3 and the transmitter's address MN′1_addr@R′3, and setting an extended header related to a terminal on the destination address side to include an action designator, address-range designating information about the mobile terminal MN1 (with which the mobile terminal MN′1 communicates) is described, and by setting an extended header related to a terminal on the transmitter's address side to include a no-operation designator, address-range designating information about the mobile terminal MN′1 is described. If the designator in the extended header related to the terminal on the transmitter's address side is set to designate action, each router ignores the designator so that local broadcasting or multicasting is not performed.

For example, in the case of transmitting an extended packet from the mobile terminal MN1 intranet (organization A) to the mobile terminal MN′1 intranet (organization B), by setting a normal header to include the destination address MN′1_addr@R3 and the transmitter's address MN1_addr@R3, and setting an extended header related to a terminal on the destination address side to include an action designator, address-range designating information about the mobile terminal MN′1 (with which the mobile terminal MN1 communicates) is described, and by setting an extended header related to a terminal on the transmitter's address side to include a no-operation designator, address-range designating information about the mobile terminal MN1 is described. If the designator in the extended header related to the terminal on the transmitter's address side is set to designate action, each router ignores the designator so that local broadcasting or multicasting is not performed.

In the above examples, if the other party already knows address-range designating information, it is also possible to omit the address-range designating information in the extended packet related to the terminal on the transmitter's address side.

In another method, while packets are mutually reached between the mobile terminal MN1 and the mobile terminal MN′1 (e.g., a case in which both the mobile terminal MN1 and the mobile terminal MN′1 do not move, or a case in which only one of the mobile terminal MN1 and the mobile terminal MN′1 moves), by exchanging information about a possibility of moving and address-range designating information to be used, an extended packet (see FIG. 3) similar to that in the above embodiments may be transmitted by regarding the mobile terminal MN1 as a fixed terminal in transmission from the mobile terminal MN1 to the mobile terminal MN′1, while an extended packet (see FIG. 3) similar to that in the above embodiments may be transmitted by regarding the mobile terminal MN′1 as a fixed terminal in transmission from the mobile terminal MN′1 to the mobile terminal MN1. In addition, when one terminal has a possibility of moving beyond the address-range designating information posted to the other party, the one terminal may notify the other of the possibility and new address-range designating information before moving.

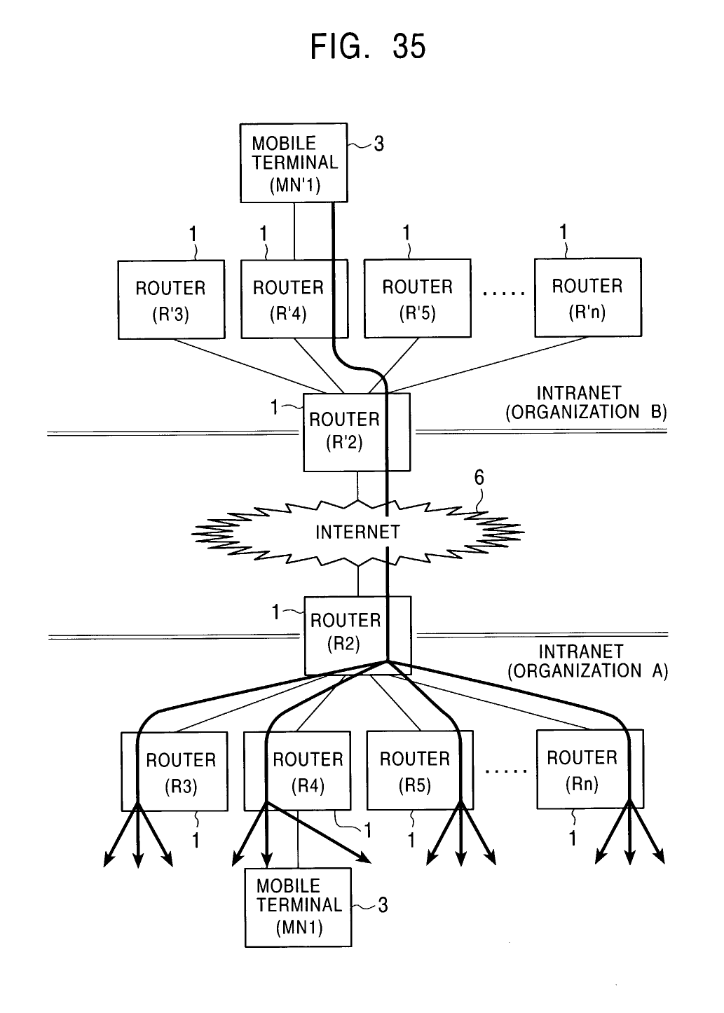

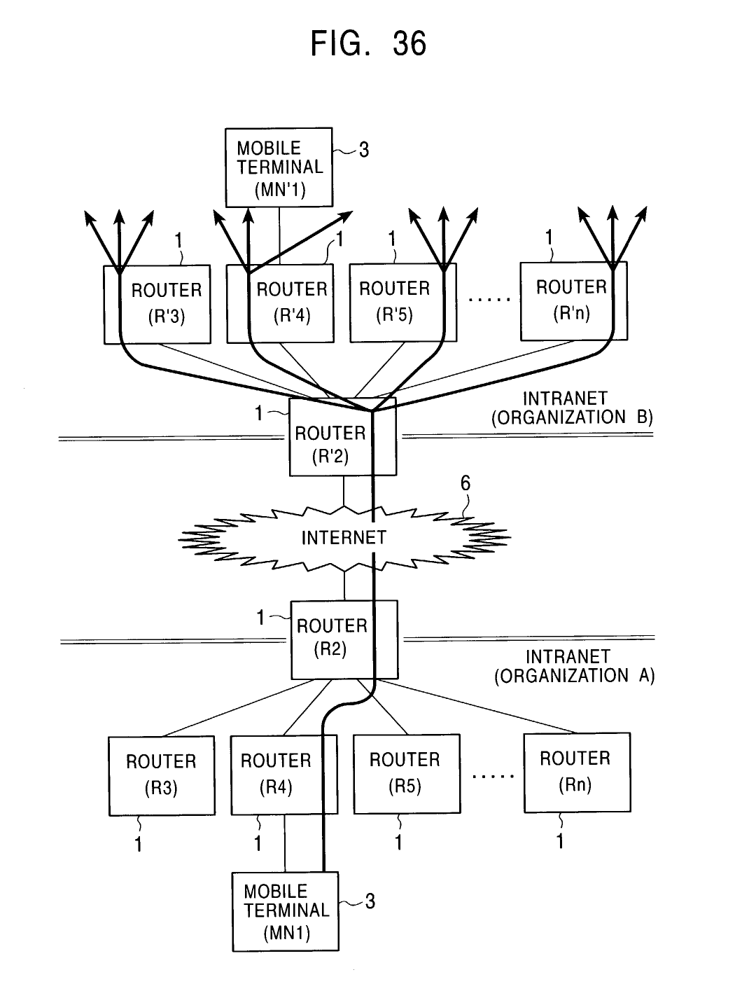

In the communication between the mobile terminal MN1 in the intranet (organization A) and the mobile terminal MN′1 in the intranet (organization B), as FIGS. 35 and 36 show, also when one of both terminals performs transmission, local broadcasting and multicasting is performed in the intranet of the other party. In this way, communication can be performed, even if both terminals are mobile terminals.

The above-described functions can be implemented by software.

Also, the above-described embodiments can be implemented by a program for controlling a computer to execute predetermined means (or for controlling a computer to function as predetermined means, or controlling a computer to implement predetermined functions), and by a computer-readable recording medium containing the program.

The foregoing constructions are only the preferred embodiments of the present invention, and are not intended to exclude other constructions. Another construction is also possible which is obtained by replacing part of each construction, omitting part of each construction, providing each construction with another function or element, or combining these. In addition, another construction which is logically equivalent to each construction, another construction including a portion which is logically equivalent to each construction, another construction which is logically equivalent to the main parts of each construction, etc., are also possible. Moreover, another construction for achieving an object which is identical or similar to that of each construction, another construction having an advantage which is identical or similar to that of each construction, etc., are also possible.

The modifications of the components described in the preferred embodiments may be implemented in combination, if needed.

The preferred embodiments includes inventions made in various aspects, levels, concepts, and categories, such as an invention of a separate device, an invention of at least two related devices, an invention of a system, an invention of a component in a separate device, and methods for these.

Therefore, from the contents disclosed in the embodiments, the invention can be extracted without being limited by the described constructions.

The present invention is not limited to the described embodiments, and may be variously modified in the technical scope thereof for implementation.

What is claimed is:

1. A packet transfer method between a mobile terminal which can move from 1st network associated with 1st router to 2nd network associated with 2nd router, and a communication node through the Internet, comprising:
transmitting 1st packet including address-range designating information for designating the range of address to which said mobile terminal can move, and NOP (no-operation designating information), from said mobile terminal to said 1st router, toward said communication node, in said mobile terminal;
forwarding received 1st packet by performing normal routing, from 1st router toward said communication node, in said 1st router;
receiving said 1st packet transmitted by said 1st router, in said communication node;
transmitting 2nd packet from said communication node toward said mobile terminal, including said address-range designating information as destination address-range and ACTION (operating designating information), in response to the 1st packet received by said communication node;
receiving said 2nd packet from said communication node, in said 2nd router;
forwarding received 2nd packet through at least one network interface with corresponds to the address range based on the address-range designating information in the received another extended packet, from said 2nd router toward said mobile terminal; and
receiving said 2nd packet from said 2nd router, when the destination address of the transferred extended packet indicates said mobile terminal.

2. A packet transfer method according to claim 1, wherein said 1st network and 2nd network belong a intranet.

3. A mobile terminal which can change the mobile terminal's present address when the mobile terminal moved, comprising:
a packet transmitting unit transmits, toward a communication node with which said mobile terminal communicates, 1st packet including address-range designating information for designating the range of addresses to which said mobile terminal can move; and
a packet receiving unit receives 2nd packet which includes the address-range designating information and which is addressed to said mobile terminal, from said communication node.

4. A mobile terminal which can change the mobile terminal's present address when the mobile terminal moved, according to claim 3 further comprising:
a normal-packet transmitting unit transmits 1st normal packet including a source address which is the present address of said mobile terminal, toward said communication node; and
a normal-packet receiving unit receives 2nd normal packet including a destination address which is the present address of said mobile terminal.

5. A mobile terminal which can change the mobile terminal's present address when the mobile terminal moved, according to claim 4 further comprising:
a determination unit determinates which type of transmission is performed between packet transmission by said packet transmitting unit and normal-packet transmission by said 1st normal-packet transmitting unit when transmitting a packet toward said communication node,

6. A mobile terminal which can change the mobile terminal's present address when the mobile terminal moved, according to claim 5, wherein said determination unit determines, based on predetermined information, whether or not said mobile terminal has a possibility of moving, and when said determination unit determines that said mobile terminal has a possibility of moving, and/or when said mobile terminal must perform continuous communication after moving, said determination unit determines that said packet transmitting unit is used to transmit the packet.

7. A mobile terminal which can change the mobile terminal's present address when the mobile terminal moved, according to claim 6, wherein said predetermined information includes information input by a user, information obtained from a radio station with which said mobile terminal communicates, information obtained by using the Global Positioning System, or information of an elapse time after said mobile terminal moves from a predetermined starting point.

8. A mobile terminal which can change the mobile terminal's present address when the mobile terminal moved, according to claim 5, wherein, when said mobile terminal only needs to establish new connection after moving, said determination unit determines that said normal-packet transmitting unit is used to transmit the 1st normal packet, irrespective of the possibility of moving of said mobile terminal.

9. A mobile terminal which can change the mobile terminal's present address when the mobile terminal moved, according to claim 5, further comprising address-retaining unit retains at lease one address obtained after said mobile terminal moves,
wherein, when the destination address of the packet matches one of the addresses retained in said address-retaining unit, said packet transmitting unit determines that the packet is addressed to said mobile terminal.

10. A mobile terminal which can change the mobile terminal's present address when the mobile terminal moved, according to claim 5, wherein:
the address of said mobile terminal includes assigned globally-unique unit-identification information as a component; and
when the unit-identification information of the destination address in the packet matches unit-identification information assigned to said mobile terminal, said packet receiving unit determines that the packet is addressed to said mobile terminal.

11. A mobile terminal which can change the mobile terminal's present address when the mobile terminal moved, according to claim 5, wherein, in the address-range designating information included in the packet, the range of addresses to which the packet must be transferred is represented by information representing the start bit of the addresses and information representing a bit length from the start bit.

12. A router for packet forwarding, comprising:
a communication interface unit having a plurality of network interfaces;
a receiving unit receives one of a normal packet, and an extended packet including address-range designating information for designating the range of addresses to which a packet is transferred and one of operation designating information for designating packet transfer to the designated address range and NOP (no-operation designating information) for designating normal routing;
1st forwarding unit forwards received one of the normal packet and/or the packet including the NOP, by using the normal routing;
2nd forwarding unit forwards received the packet including the ACTION (operating designating information), through at least one of the network interfaces which corresponds to the address range based on the address-range designating information included in the received packet.

13. A router for packet forwarding, according to claim 12, further comprising a performing unit at least one of updating the address-range designating information included in the extended packet, changing the operation designating information to the no-operation designating information, and changing the no-operation designating information to the operation designating information.

14. A router for packet forwarding, according to claim 12, wherein, when said router receives the packet including the operation designating information, and determines that a communication node to which the packet is addressed is not found on the path of the network interface which corresponds to the address range based on the address-range designating information, said router does not forward the packet through the at least one network interface

15. A communication node for use in communication with a mobile terminal whose present address can change when said mobile terminal moves, comprising:
a packet receiving unit receives, from said mobile terminal, 1st packet including address-range designating information for designating the range of addresses to which said mobile terminal can move; and
a packet transmitting unit transmits, toward said mobile terminal, 2nd packet including address-range designating information designated by said mobile terminal.

16. A communication node according to claim 15, further comprising:
a normal-packet receiving unit receives, from said mobile terminal, a normal packet including a destination address which is the present address of said communication node; and
a normal-packet transmitting unit transmits, toward said mobile terminal, a normal packet including a transmitter's address which is the present address of said communication node.

17. A communication node according to claim 15, wherein the packet includes one of operation designating information and no-operation designating information in which the operation designating information instructs a router which receives the extended packet to transfer the extended packet through at least one network interface of the router which corresponds to the address range based on the address-range designating information included in the received extended packet, and the no-operation designating information for instructing the router to perform normal routing.

18. A communication node according to claim 17, wherein, when said communication node performs packet transmission to said mobile terminal in response to the extended packet including the no-operation designating information which is received from said mobile terminal, said extended-packet transmitting means transmits the extended packet including the operation designating information.

19. A program for controlling a computer to function as a mobile terminal whose present address can change when said mobile terminal moves, said program causing said computer to implement the functions of:
transmitting, to a node with which said mobile terminal communicates, an extended packet including address-range designating information for designating the range of addresses to which said mobile terminal can move; and
receiving an extended packet which includes the address-range designating information and which is addressed to said mobile terminal.

20. A program for controlling a computer to function as a router unit for packet relaying, said program causing said computer to implement the functions of:
receiving one of a normal packet, and an extended packet including address-range designating information for designating the range of addresses to which a packet is transferred and one of operation designating information for designating packet transfer to the address range designated by the address-range designating information and no-operation designating information for designating normal routing;
when one of the normal packet and the extended packet including the no-operation designating information is received, transferring the received packet by using the normal routing; and
when an extended packet including the operation designating information is received, transferring the received extended packet through at least one of the network interfaces which corresponds to the address range based on the address-range designating information included in the received extended packet.
